(19) United States
(12) Patent Application Publication
(10) Pub. No.: US 2025/0031697 A1
(43) Pub. Date: Jan. 30, 2025

(54) METHODS AND COMPOSITIONS TO PREVENT PLANT PESTS AND PATHOGENS

(71) Applicant: Impello Biosciences, Inc., Fort Collins, CO (US)

(72) Inventors: Michael C. KEY, Fort Collins, CO (US); Lindsey R. ADLER, Fort Collins, CO (US); Michael J. DILEGGE, Longmont, CO (US)

(21) Appl. No.: 18/716,799

(22) PCT Filed: Dec. 9, 2022
(86) PCT No.: PCT/US2022/081326

§ 371 Date: Jun. 5, 2024

Related U.S. Application Data
(60) Provisional application No. 63/287,939, filed on Dec. 9, 2021.

(51) Int. Cl. A01N 37/42; A01N 63/22; A01P 1/00; A01P 3/00; A01P 17/00

(52) U.S. Cl. CPC A01N 37/42; A01N 63/22; A01P 1/00; A01P 3/00; A01P 17/00

(57) ABSTRACT

The disclosure relates to compositions and methods of use for plant protection against pests and pathogens comprising applying an effective amount of a jasmonate, or a composition comprising at least one jasmonate. In some instances, the protection is prophylactic, and inhibits, prevents and/or repels insects and other pests from contacting plants and/or feeding on plants, thereby deterring plant damage and transmission of plant pathogens. In some embodiments, the methods and compositions are a treatment for a pest infestation. In some embodiments, the methods and compositions prevent or treat a pathogen. In some embodiments, the jasmonate or composition comprising at least one jasmonate is applied in conjunction with a soil inoculate of beneficial root microorganisms.

### CROSS-REFERENCE TO RELATED APPLICATIONS

This application claims the benefit of U.S. Patent Application No. 63/287,939, filed Dec. 9, 2021, entitled “Methods And Compositions To Prevent Plant Pests And Pathogens,” the disclosure of which is hereby incorporated by reference in its entirety.

### TECHNICAL FIELD

The disclosure relates to compositions and methods of use to prevent plant pest infestations and pathogen transmission.

### BACKGROUND

In 2020, the global pesticide use was estimated at 3.5 million tons (Zhang W, (2018) Proc Int Acad Ecol Environ Sci 8(1):1-27), with the U.S. and China being the top two consumers. While there are programs and guidelines in place to regulate use, a prospective study in the U.S. found that 16% of the cohort had at least one pesticide poisoning or an unusually high pesticide exposure episode in their lifetime (Alavanja M C, et al., Am J Ind Med. 2001 June; 39 (6): 557-63). Moreover, in 2000 the U.S. Department of Agriculture estimated that 50 million people were drinking groundwater that was potentially contaminated with pesticides (Ward M H, et al., Environ Health Perspect. 2000 January; 108(1):5-12). In addition to health risks, certain pesticides also have negative environmental impacts.

However, with approximately 45% of food production lost due to pest infestation pest control continues to be necessary, but there remains a need to deter pests in a safer, more environmentally conscientious way. The use of the biochemical and biological based pesticides or repellants may provide for limited negative effects (if any) on surrounding ecosystems, whether those be riparian, urban, or agricultural. As such, the use of these low-risk compounds, especially in a preventative nature, will reduce the use of “high-risk” or compounds falling into the category of high regulatory concern.

### SUMMARY

The present disclosure teaches a method for prophylactic pest or pathogen control comprising applying a jasmonate or a composition comprising a jasmonate to a plant, plant part, or the root zone of the plant, wherein said application prevents or reduces pest and/or pathogen damage compared to untreated controls. In some aspects the method further comprises applying a biological, e.g., a plant beneficial microbe.

The disclosure further teaches a method for treating a plant pathogen or pest infestation comprising applying a jasmonate or a composition comprising a jasmonate to a plant, plant part, or the root zone of the plant, wherein said application reduces pest and/or pathogen damage compared to untreated controls. In some aspects the method further comprises applying a biological, e.g., a plant beneficial microbe.

The disclosure further relates to compositions comprising at least one jasmonate, a biological, and an emulsifier, and methods of using the composition.

### BRIEF DESCRIPTION OF THE DRAWINGS

FIG. 1 is a bar graph showing the results of various treatments on hemp plants infected with Botrytis cinerea compared to an untreated control. Plants were scored on a scale of 0-5 and averaged, with 0 indicating no signs of infection.

### DETAILED DESCRIPTION

### Definitions

As used herein, the term “about” refers to plus or minus 10% of the referenced number, unless otherwise stated or otherwise evident by the context (such as when a range would exceed 100% of a possible value or fall below 0% of a possible value). For example, reference to a value of “about 1%” means that the value may be present at any amount ranging from 0.9% to 1.1%. The term “about” also refers to plus or minus a day when referring to a length of time measured in days.

The term “a” or “an” refers to one or more of that entity; for example, “a gene” refers to one or more genes or at least one gene. As such, the terms “a” (or “an”), “one or more” and “at least one” are used interchangeably herein. In addition, reference to “an element” by the indefinite article “a” or “an” does not exclude the possibility that more than one of the elements is present, unless the context clearly requires that there is one and only one of the elements.

The International Code of Zoological Nomenclature defines rank, in the nomenclatural sense, as the level, for nomenclatural purposes, of a taxon in a taxonomic hierarchy (e.g., all families are for nomenclatural purposes at the same rank, which lies between superfamily and subfamily). While somewhat arbitrary, there are seven main ranks defined by the international nomenclature codes: kingdom, phylum/division, class, order, family, genus, and species.

As used herein, the term “biopesticide” refers certain types of pesticides derived from such natural materials as animals, plants, bacteria, and certain minerals. There are generally three categories of biopesticides, including microbial biopesticides, biochemical biopesticides, and plant-incorporated protectants (PIPs).

As used herein, a “biochemical biopesticide” or a “biochemical pesticide” is a compound (or synthetic analog) of natural origin that controls pests by means that are non-toxic. For example, a conventional pesticide composed of a synthetic material may directly kill or inactivate the pest, whereas a biochemical biopesticides may interfere with mating. Secondary metabolites are an example of a biochemical biopesticide.

As used herein, “microbial pesticides” refer to pesticides having a microorganism (e.g., a bacterium, fungus, virus or protozoan) as the active ingredient.

As used herein, “Plant-Incorporated-Protectants” (PIPs) refers to pesticidal substances that plants produce from genetic material that has been added to the plant.

As used herein, the term “jasmonate or jasmonates” refers to a class of compounds modulating plant responses to abiotic and biotic stimuli. The compounds may be produced endogenously in a plant, exogenously applied to a plant, or of synthetic origin, and include ethyl jasmonate, jasmonic acid, methyl dihydrojasmonate, cis-jasmone, transjasmone, methyl (+)-7-isojasmonate, dihydrojasmonate, prohydrojasmone, isojasmone, methyl dihydro iso jasmonate, and their homologues or analogues, isomers, derivatives or conjugates thereof

As used herein, the phrase “economic threshold” refers to the density of a pest at which a control treatment by conventional pesticide use will provide an economic return. The goal of the economic threshold is to prevent an infestation reaching a point where it causes monetary losses that are equal to the cost of control (a break-even referred to as economic injury level). Thus, the economic threshold for insects refers to the timing for applying a pesticide which is based on the number of insects per plant, per plant part or per defined geographical area, such as the number of a particular insect per acre or per hectare. The number of insects can be determined visually or by any other suitable method, such as but not limited to inspection of the plant or part using a microscope or other suitable instrument. The insect density can be based on the number of whole insects, insect eggs, insect parts, insect damage, or by any other suitable method and combinations of all such methods. The insect density considered to be the economic threshold for a particular insect on a particular plant species varies depending on the factors such as the particular insect species, plant species, plant parts, plant development stage, commodity prices for the crop and the relative cost of pesticide and application.

As used herein, “economic injury level” (EIL) refers to the break-even point wherein the pest causes monetary damages equal to the cost of control, and can be calculated as follows: EIL=C/(V)×(I)×(D)×(K), wherein C=cost of control (e.g., per plant), V=value of the commodity (e.g., per pound), I=Injury (e.g., damaged fruit based on given density of insects), D=economic damage (e.g., bushels lost or quality discount), and K=percent control (e.g., reduction in damage with control measures).

As used herein, a “disease vector” is any living agent that carries and transmits an infectious pathogen to another living organism.

As used herein, “hemp” refers to a cannabis variety having less than 0.3% THC in the inflorescence tissue. In some embodiments the determination of whether a cannabis plant is hemp occurs at harvest maturity for the flower, however, a plant does not have to be flowering, mature, or even sprouted to be considered hemp.

As used herein, “altering” or “altered” may refer to an increase or decrease relative to a control value.

As used herein, “plant beneficial microbe(s)” refers to microorganisms that create symbiotic associations with plant roots, promote nutrient mineralization and availability, produce plant growth hormones, and are antagonists of plant pests, parasites or diseases.

As used herein, a “biostimulant” refers to a substance or micro-organism that, when applied to seeds, plants, or the rhizosphere, stimulates natural processes within the plant or the plant microbiome (including the entirety of the phytomicrombiome, e.g. the phyllosphere and rhizosphere) to enhance or benefit nutrient uptake, nutrient efficiency, tolerance to abiotic stress, or crop quality and yield.

As used herein, a “biological” or “agricultural biological” refers to a category of products derived from naturally occurring microorganisms, plant extracts, or other organic matter. In some embodiments, the biological is created from and/or contains living organisms, beneficial insects, plant extracts, or other organic matter.

The “root zone” of a plant refers to the area of the plant comprising the roots and the surroundings of the roots. In soil surroundings, the root zone is the region of soil in which the roots of the plant can take up water.

### Overview

Plants naturally produce both primary (essential) and secondary (non-essential) metabolites during growth. Numerous secondary metabolites, including alkaloids, terpenoids and isoprenoids, and phenolics, among others, have been shown to contribute to plant defense against pests and pathogens. The disclosure relates to compositions and methods of use for plant protection against pests and pathogens comprising applying an effective amount of a jasmonate, or a composition comprising at least one jasmonate. The disclosure also relates to compositions and methods of use for plant protection against pests and pathogens comprising applying an effective amount of a jasmonate and an effective amount of a biological.

In some instances, the protection is prophylactic, and inhibits, prevents and/or repels insects and other pests from contacting plants and/or feeding on plants, thereby deterring plant damage and transmission of plant pathogens. In some embodiments, the methods and compositions are a treatment for a pest infestation. In some embodiments, the methods and compositions prevent or treat a pathogen. In some embodiments, the jasmonate or composition comprising at least one jasmonate is applied in conjunction with a biological comprising a soil inoculate of beneficial root microorganisms.

By using both jasmonates and biologicals, a microclimate is created on and within the plant body, wherein the competing microbes, the jasmonate, and the endogenous plant defense signaling compounds (activated through exogenous jasmonate application), provide an unfavorable environment for pests such as insects, and pathogens, such as fungi. The creation of a “disease suppressive microclimate” on and within the plant can minimize the use of high-risk chemicals that otherwise may drift and cause negative effects on surrounding environments.

### Jasmonates

Compositions of the present disclosure comprise jasmonates.

Certain biochemicals are known to function endogenously within the plant and play roles within plant hormone signal transduction. Jasmonic Acid (JA) and Salicylic Acid (SA), which correspond to the Jasmonic Acid pathway and Salicylic Acid pathway in higher plants are responsible for modulating plant responses to abiotic and biotic stimuli. These biosynthetic pathways derive from alpha-linolenic acid metabolism and phenylalanine metabolism, respectively, and in some plant species are antagonists of each other; when JA pathways are upregulated, SA pathways are repressed, and vice versa. This phenomenon can be described in one sense by the chemical's relationship to the octadecanoid pathway, which is responsible for the production of jasmonic acid. Salicylates demonstrate negative crosstalk with jasmonates and likewise are considered inhibitors of the octadecanoid pathway.

Jasmonic acid (JA) is one of several endogenous lipid-based octadecanoid derivatives that are known to act as elicitors of plant defense, along with its methyl ester (methyl jasmonate, MeJA) and other derivatives (Saniewski M. (1997) The Role of Jasmonates in Ethylene Biosynthesis. In: Kanellis A. K., Chang C., Kende H., Grierson D. (eds) Biology and Biotechnology of the Plant Hormone Ethylene. NATO ASI Series (3. High Technology), vol 34). Jasmonates generally follow the same fundamental biosynthetic steps in plants, starting with the oxygenation of alpha-linolenic acid by lipoxygenase (13-LOX), which cyclizes to form allene oxide and then rearranges to form 12-oxophytodienoic acid (12-OPDA), which is then transformed into 7-iso-jasmonic acid via R-oxidations and can isomerize into JA. JA can then decarboxylate into the bioactive cis-jasmone (CJ), conjugate with isoleucine to produce JA-lle, or be metabolized into Methyl Jasmonate (MeJA), among others (Matsui, R., et al. Elucidation of the biosynthetic pathway of cis-jasmone in Lasiodiplodia theobromae. Sci Rep 7, 6688 (2017)).

Jasmonate derivatives, or derivatives of the octadecanoid pathway comprised of a cyclopentanone ring, cyclopentene ring, or other ketone may include an alkane chain or an alkene chain, or may include a different hydrocarbon chain and may include a carboxylic acid side chain of different lengths.

In some embodiments, the jasmonate is methyl jasmonate. Shown below is the structure for Methyl Jasmonate (MeJA) (from National Center for Biotechnology Information (2021). PubChem Compound Summary for CID 5281929, Methyl jasmonate).

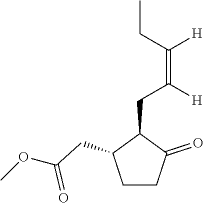 [SMILES: CC/C=C\C[C@H]1C(=O)CC[C@@H]1CC(=O)OC]

In some embodiments, the jasmonate is methyl dihydrojasmonate. Shown below is the structure for methyl dihydrojasmonate (MDJ) (National Center for Biotechnology Information (2021). PubChem Compound Summary for CID 102861, Methyl dihydrojasmonate).

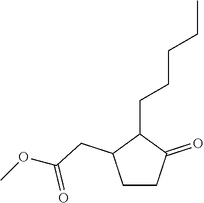 [SMILES: CCCCCC1C(=O)CCC1CC(=O)OC]

In some embodiments, the jasmonate is cis-jasmone. Shown below is the structure for cis-jasmone (CJ) (National Center for Biotechnology Information (2021). PubChem Compound Summary for CID 1549018, Jasmone).

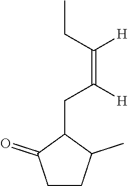

All jasmonates and even jasmonate-like molecules, including (+)-cucurbic acid and tuberonic acid, share some similarities in their chemical structures, such as cyclopentanone rings. However specific jasmonate-type responses in plants may be structure dependent and based on the presence of hydroxyl groups, methyl groups, hydrocarbon chains, carboxylic acid chains, or other functional groups, or may be dependent on the chirality of each jasmonate type compound, or may be dependent on the compound's stereoisomerism, or may be dependent on the compound's spatial isomerism, or otherwise dependent on the structure.

Prohydrojasmone (PDJ) is a synthetic derivative of jasmonic acid previously shown to increase anthocyanin and bring about the red color in apples (BLUSH™). Methyl dihydrojasmonate is only produced endogenously in a few plants, thus its ability to function as an elicitor to increase endogenous plant defenses was previously unresearched. Additionally, jasmonate derivatives like cis-jasmone (CJ) may be used to elicit more specific responses when applied exogenously in planta in comparison to the standard jasmonate elicitors like JA and MeJA.

### Illustrative Jasmonates of the Disclosure

In some aspects, the jasmonate is selected from the group consisting of jasmonic acid, methyl dihydrojasmonate, cis-jasmone, transjasmone, methyl (+)-7-isojasmonate, dihydrojasmonate, prohydrojasmone, isojasmone, methyl dihydro iso jasmonate, and their homologues or analogues, isomers, derivatives or conjugates thereof. In some embodiments, the jasmonate is a synthetic. In some aspects, the jasmonate is methyl dihydrojasmonate. In some aspects, the jasmonate is cis-jasmone.

In some aspects, the composition comprises two jasmonates. In some aspects, the two jasmonates are methyl dihydrojasmonate and cis-jasmone.

In some embodiments, the composition may be prepared as a concentrate for industrial application and further dilution or as a fully diluted ready-to-apply composition. For example, in some embodiments, a ready-to-apply composition comprises between about 1 mM and about 10 mM jasmonate. In some aspects, the composition comprises about 0.1 mM, 0.2 mM, 0.3 mM, 0.4 mM, 0.5 mM, 0.6 mM, 0.7 mM, 0.8 mM, 0.9 mM, 1 mM, 2 mM, 3 mM, 4 mM, 5 mM, 6 mM, 7 mM, 8 mM, 9 mM or 10 mM of at least one jasmonate, including all ranges and subranges therebetween. In some embodiments, the composition comprises less than about 1 mM, 2 mM, 3 mM, 4 mM, or 5 mM jasmonate. In some aspects, the composition comprises between about 0.1-1 mM, between about 1-2 mM, between about 2-3 mM, between about 3-4 mM, between about 4-5 mM, between about 5-6 mM, between about 6-7 mM, between about 7-8 mM, between about 8-9 mM, or between about 9-10 mM of a jasmonate. In some embodiments, the composition comprises about 1 mM of a jasmonate. In some embodiments, the composition may be formulated as a spray-to-drip foliar spray. In some embodiments, the composition comprises between 350-850 ppm jasmonate. In some embodiments, the composition comprises between 850-1700 ppm jasmonate.

In some embodiments, the ratio of jasmonate to an individual plant beneficial microbe comprised by a biological herein is about 1 mM jasmonate:10² CFU/mL, 1 mM jasmonate:10³ CFU/mL, 1 mM:10⁴ CFU/mL, 1 mM:10⁵ CFU/mL, 1 mM:10⁶ CFU/mL, 1 mM:10⁷ CFU/mL, or 1 mM:10⁸ CFU/mL, including all ranges and subranges therebetween.

### Biologicals

In some embodiments, the disclosure provides for compositions and methods of using both biological (e.g., microbial) and biochemical (jasmonate) applications targeted toward pests and pathogens. In some embodiments, the jasmonate or composition comprising a jasmonate is applied in combination with one or more biologicals.

Biologicals are products that are created from, or derived from, living organisms, plant extracts, beneficial insects, or other organic matter. Additional names in the art include, for example, bioeffector, biocontrol agent, bioherbicide, bioactivity, biorational insecticide, and biodigester.

In recent years they have become a valuable tool in sustainable agriculture. Induced Systemic Resistance (ISR) is a phenomenon characterized by soil-inhabiting rhizobacteria repressing soil-borne, necrotrophic pathogens. ISR is the emergence of plant-wide pest resistance triggered from an abiotic stress, such as plant interaction with a biological. Thus in some embodiments, contacting a biological to a plant may cause the plant to develop resistance to one or more pests. In some embodiments, the biological itself also exhibits pest control properties. Numerous pathogens are also susceptible to jasmonate-mediated defense (Glazebrook, J. Contrasting Mechanisms of Defense Against Biotrophic and Necrotrophic Pathogens, Ann. Rev. of Phytopathology (2005) 43:205-227). Therefore, in some embodiments, by reinforcing jasmonate mediated defenses through ISR elicitation, biologicals comprising beneficial bacteria enhance biocontrol.

In some embodiments, a biological comprised by a composition herein, or employed in a method herein, comprises a biostimulant, a biopesticide, or a biofertilizer. In some embodiments, a biological herein is a composition comprising microbes. In some embodiments, a biological herein comprises a rhizobacterium. In some embodiments, the biological comprises a Bacillus sp. In some embodiments, the biological comprises Azospirillum sp. In some embodiments, the biological comprises Pantoea sp. In some embodiments, a biological herein comprises an Agrobiotech product from Probelte®. In some embodiments, a biological herein comprises a product from Impello®.

In some embodiments, a biological herein is a composition comprising microbes. In some embodiments, a biological herein is a product listed in Table 1. In some embodiments, a biological herein comprises a bacterial strain listed in Table 1.

TABLE 1
Illustrative biological products and bacterial strains.

| Product | Strains |
|---|---|
| Impello ® Tribus ® | Bacillus subtilis strain Itri1 |
| | Bacillus pumilus strain Itri2 |
| | Bacillus amyloliquefaciens strain Itri3 |
| Impello® Continuum | Paenibacillus chitinolyticus strain Icon1, |
| | Bacillus subtilis strain Icon2 |
| | Bacillus pumilus strain Icon3 |
| | Bacillus amyloliquefaciens strain Icon4 |
| Probelte ® Biopron or | Azospirillum brasilense strain Pbiol |
| Biopron Premium | Pantoea dispersa strain Pbio2 |
| Probelte ® Bøtrybël ™ | Bacillus amyloliquefaciens strain Pbot1 |
| Probelte ® Bulhnova ™ | Azospirillum brasilense strain Pbul1 |
| | Pantoea dispersa strain Pbul2 |
| Probelte ® Nemapron ™ | Azospirillum sp. strain Pnem1 |
| | Bacillus spp. strain Pnem2 |
| Probelte ® Strongest ™ | Azospirillum brasilense strain Pstr1 |
| Probelte ® Belthirul ™ | Bacillus thuringiensis var. kurstaki strain Pbel1 |
| Probelte ® Belthirul ™ F | Bacillus thuringiensis var. kurstaki strain Pbel1F |
| Probelte ® Belthirul ™ S | Bacillus thuringiensis var. kurstaki strain Pbel1S |
| Probelte ® Belthirul ™ 16 SC | Bacillus thuringiensis var. kurstaki strain Pbel116SC |
| Probelte ® Lepiback ™ | Bacillus thuringiensis var. kurstaki strain Plep1 |

In some embodiments, a biological herein comprises any of the species or strains listed in Table 1. In some embodiments, the biological comprises about 10⁴, 10⁵, 10⁶, 10⁷, 10⁸, 10⁹, or 10¹⁰ CFU/mL of a microbe listed herein. In some embodiments, the biological comprises about 10⁷, 10⁸, 10⁹, or 10¹⁰ CFU/g of a microbe listed herein.

### Biostimulants

In some embodiments, the biological comprises a biostimulant. Biostimulants are substances or microorganisms that, when applied to seeds, plants, or the rhizosphere, stimulate natural processes within the plant or the plant microbiome (including the entirety of the phytomicrombiome, e.g. the phyllosphere and rhizosphere) to enhance or benefit nutrient uptake, nutrient efficiency, tolerance to abiotic stress, or crop quality and yield. In some embodiments, the biological is a biostimulant. In some embodiments, the biostimulant comprises humic substances, hormones, cell signaling molecules, seaweed extract, and/or amino acids.

In some embodiments, the biological is selected from auxins, cytokinins, gibberellins, abscisic acid, ethylene, brassinosteroids, jasmonic acid, strigolactones, chemical mimics of strigolactone, and combinations thereof.

In some embodiments, the biostimulant comprises a strigolactone or chemical mimics of strigolactone. Such compounds are described in PCT/US2016/029080, filed Apr. 23, 2016, and entitled: Methods for Hydraulic Enhancement of Crops, and US2021/0329917, published Oct. 28, 2021 and entitled: Compounds and Methods for Increasing Soil Nutrient Availability, which are hereby incorporated by reference. They are further described in U.S. Pat. No. 9,994,557, issued on Jun. 12, 2018, and entitled: Strigolactone Formulations and Uses Thereof, which is hereby incorporated by reference.

### Biopesticides

In some embodiments, the biological comprises a biopesticide. Biopesticides include any naturally occurring substance that controls pests, known as biochemical pesticides, microorganisms that control pests, known as microbial pesticides, and pesticidal substances produced by plants containing added genetic material-known as plant-incorporated protectants or PIPs. Biopesticides can also include semiochemicals, peptides, proteins and nucleic acids such as double-stranded DNA, single-stranded DNA, double-stranded RNA, single-stranded RNA and hairpin DNA or RNA. In some embodiments, the biological is a biopesticide disclosed in Table 2.

TABLE 2
Examples of Biopesticides

| Source | Type | Organism | Pest Type |
|---|---|---|---|
| Bacteria | Insecticide | Bacillus thuringiensis | caterpillars, fungi |
| | | var kurstaki | (Botrytis) Elm |
| | | B. thuringiensis var | Leaf Beetle, |
| | | tenebrionis | Alfalfa weevil |
| | Fungicide | Bacillus subtilis | Botrytis spp. |
| Fungi | Insecticide | Beauveria bassiana | Whitefly |
| | Fungicide | Coniothyrium | Sclerotinia spp. |
| | | minitans | S sclerotiorum |
| | | Trichoderma | |
| | | harzianum | |
| | Herbicide | Chondrostereum | cut stumps of |
| | | purpureum | hardwood trees |
| | | | and shrubs |
| | Nematicide | Paecilomyces | plant-parasitic |
| | | lilacinus | nematodes in soil |
| Virus | Insecticide | Cydia pomonella | codling moth |
| | | granulovirus | |
| Oomycetes | Herbicide | Phytophthora | Morenia orderata |
| | | palmivora | |
| Neem | Insecticide | Azadirachtin | aphids, scale, |
| (Azadirachta | | | thrips, whitefly, |
| indica) | | | leafhoppers, |
| | | | weevils |
| Plant extracts | Fungicide | Reynoutria | powdery mildew, |
| | | sachalinensis (giant | downy mildew, |
| | | knotweed) extract | Botrytis, late |
| | | | blight, citrus |
| | | | canker |
| | Herbicide | Plant essential oils | Ragwort, many |
| | | | arthropods |
| | Nematicide | Quillaja saponaria | plant parasitic |
| | | | nematodes |
| Talaromyces | Biopesticides | | Glomerella |
| flavus; Clitoria | | | cingulata and |
| ternatea (butterfly | | | Colletotrichum |
| pea); Trichoderma | | | acutatum; |
| harzianum; | | | Helicoverpa spp.; |
| Bacillus | | | Fusarium |
| thuringiensis var. | | | oxysporum |
| tenebrionis; | | | Agelastica alni; |
| Lactobacillus casei | | | Spodoptera litura, |
| fermentation | | | Helicoverpa |
| products | | | armigera, Aphis |
| | | | gossypii; |
| | | | Xanthomonas |
| | | | fragariae; |
| | | | Spodoptera |
| | | | littoralis and |
| | | | others |
| Semiochemical | Attractant | Citronellol | tetranychid mites |
| | | Multi-component sex | codling moth |
| | | pheromone, such as | |
| | | (E,E)-8,10- | |
| | | dodecadien-1-ol | |
| Arbuscular | Filamentous | Nostoc piscinale; | |
| Mycorrhizal Fungi | cyanobacterium; | Chlamydopodium | |
| | Single-celled | fusiforme; Chlorella | |
| | green algae | vulgaris | |
| | | Anabaena laxa and | Increase in |
| | | Calothrix elenkinii | fungicidal activity |
| Nanobiopesticide | Silver | | Alternaria |
| | nanobiopesticide | | alternata, A. |
| | | | solani |
| | Sargassum | | Ariadne merione, |
| | muticum derived | | a Lepidopteran |
| | NPs | | pest |
| | Caulerpa | | Culex |
| | scalpelliformis | | quinquefasciatus |
| | and | | |
| | Mesocyclops | | |
| | longisetus- | | |
| | derived NPs | | |

In some embodiments, the biological is a biochemical pesticide. Biochemical pesticides control pests by non-toxic mechanisms, such as insect sex pheromones that interfere with mating, and plant extracts that attract an insect pest to a trap or repel an insect pest. Examples of plant extracts used as biochemical pesticides are neem and lemongrass oil. A biochemical pesticide may also be an insect growth regulator, and inhibit processes required for survival of the insect.

Plants produce a wide variety of secondary metabolites that deter herbivores from feeding on them. Some of these can be used as biopesticides. They include, for example, pyrethrins, which are fast-acting insecticidal compounds produced by Chrysanthemum cinerariaefolium. They have low mammalian toxicity but degrade rapidly after application. This short persistence prompted the development of synthetic pyrethrins (pyrethroids). The most widely used botanical compound is neem oil, an insecticidal chemical extracted from seeds of Azadirachta indica. Two highly active pesticides are available based on secondary metabolites synthesized by soil actinomycetes, but they have been evaluated by regulatory authorities as if they were synthetic chemical pesticides. Spinosad is a mixture of two macrolide compounds from Saccharopolyspora spinosa. It has a very low mammalian toxicity and residues degrade rapidly in the field. Farmers and growers used it widely following its introduction in 1997 but resistance has already developed in some important pests such as western flower thrips. Abamectin is a macrocyclic lactone compound produced by Streptomyces avermitilis. It is active against a range of pest species but resistance has developed to it also, for example, in tetranychid mites.

Peptides and proteins from a number of organisms have been found to possess pesticidal properties. Perhaps most prominent are peptides from spider venom (King, G. F. and Hardy, M. C. (2013) Spider-venom peptides: structure, pharmacology, and potential for control of insect pests. Annu. Rev. Entomol. 58:475-496). A unique arrangement of disulfide bonds in spider venom peptides render them extremely resistant to proteases. As a result, these peptides are highly stable in the insect gut and hemolymph and many of them are orally active. The peptides target a wide range of receptors and ion channels in the insect nervous system. Other examples of insecticidal peptides include: sea anemone venom that act on voltage-gated Na+ channels (Bosmans, F. and Tytgat, J. (2007) Sea anemone venom as a source of insecticidal peptides acting on voltage-gated Na+ channels. Toxicon. 49 (4): 550-560); the PA1b (Pea Albumin 1, subunit b) peptide from Legume seeds with lethal activity on several insect pests, such as mosquitoes, some aphids and cereal weevils (Eyraud, V. et al. (2013) Expression and Biological Activity of the Cystine Knot Bioinsecticide PA1b (Pea Albumin 1 Subunit b). PLOS ONE 8 (12): e81619); and an internal 10 kDa peptide generated by enzymatic hydrolysis of Canavalia ensiformis (jack bean) urease within susceptible insects (Martinelli, A. H. S., et al. (2014) Structure-function studies on jaburetox, a recombinant insecticidal peptide derived from jack bean (Canavalia ensiformis) urease. Biochimica et Biophysica Acta 1840:935-944). Examples of commercially available peptide insecticides include Spear™-T for the treatment of thrips in vegetables and ornamentals in greenhouses, Spear™-P to control the Colorado Potato Beetle, and Spear™-C to protect crops from lepidopteran pests (Vestaron Corporation, Kalamazoo, MI). A novel insecticidal protein from Bacillus bombysepticus, called parasporal crystal toxin (PC), shows oral pathogenic activity and lethality towards silkworms and Cry1Ac-resistant Helicoverpa armigera strains (Lin, P. et al. (2015) PC, a novel oral insecticidal toxin from Bacillus bombysepticus involved in host lethality via APN and BtR-175. Sci. Rep. 5:11101).

A semiochemical is a chemical signal produced by one organism that causes a behavioral change in an individual of the same or a different species. The most widely used semiochemicals for crop protection are insect sex pheromones, some of which can now be synthesized and are used for monitoring or pest control by mass trapping, lure-and-kill systems and mating disruption. Worldwide, mating disruption is used on over 660,000 ha and has been particularly useful in orchard crops.

In some embodiments, the biological is a microbial pesticide. Microbial pesticides comprise a microorganism as the active ingredient. The microorganism may be a bacterium, fungus, virus, or protozoan.

An example microbial pesticide are some species and strains of Bacillus thuringiensis (Bt), which can control for example, moths, flies, and mosquitoes. Other microbial pesticides may be obtained from species of Bacillus, Pseudomonas, Yersinia, Chromobacterium, Beauveria, Metarhizium, Verticillium, Lecanicillium, Hirsutella, Paecilomyces, baculoviruses, arbuscular mycorrhizal fungi, Heterorhabditis, and Steinernema. In some embodiments, the microbial pesticide is derived from Bacillus thuringiensis.

The most widely used microbial biopesticide is the insect pathogenic bacteria Bacillus thuringiensis (Bt), which produces a protein crystal (the Bt δ-endotoxin) during bacterial spore formation that is capable of causing lysis of gut cells when consumed by susceptible insects. Microbial Bt biopesticides consist of bacterial spores and δ-endotoxin crystals mass-produced in fermentation tanks and formulated as a sprayable product. Bt does not harm vertebrates and is safe to people, beneficial organisms and the environment. Thus, Bt sprays are a growing tactic for pest management on fruit and vegetable crops where their high level of selectivity and safety are considered desirable, and where resistance to synthetic chemical insecticides is a problem. Bt sprays have also been used on commodity crops such as maize, soybean and cotton, but with the advent of genetic modification of plants, farmers are increasingly growing Bt transgenic crop varieties.

Other microbial insecticides include products based on entomopathogenic baculoviruses. Baculoviruses that are pathogenic to arthropods belong to the virus family and possess large circular, covalently closed, and double-stranded DNA genomes that are packaged into nucleocapsids. More than 700 baculoviruses have been identified from insects of the orders Lepidoptera, Hymenoptera, and Diptera. Baculoviruses are usually highly specific to their host insects and thus, are safe to the environment, humans, other plants, and beneficial organisms. Over 50 baculovirus products have been used to control different insect pests worldwide. In the US and Europe, the Cydia pomonella granulovirus (CpGV) is used as an inundative biopesticide against codlingmoth on apples. Washington State, as the biggest apple producer in the US, uses CpGV on 13% of the apple crop. In Brazil, the nucleopolyhedrovirus of the soybean caterpillar Anticarsia gemmatalis was used on up to 4 million ha (approximately 35%) of the soybean crop in the mid-1990s. Viruses such as Gemstar® (Certis USA) are available to control larvae of Heliothis and Helicoverpa species.

At least 170 different biopesticide products based on entomopathogenic fungi have been developed for use against at least five insect and acarine orders in glasshouse crops, fruit and field vegetables as well as commodity crops. The majority of products are based on the ascomycetes Beauveria bassiana or Metarhizium anisopliae. M. anisopliae has also been developed for the control of locust and grasshopper pests in Africa and Australia and is recommended by the Food and Agriculture Organization of the United Nations (FAO) for locust management.

A number of microbial pesticides are registered in the United States. See for example Kabaluk et al. 2010 (Kabaluk, J. T. et al. (ed.). 2010. The Use and Regulation of Microbial Pesticides in Representative Jurisdictions Worldwide. IOBC Global. 99pp. Microbial pesticides registered in selected countries are listed in Annex 4 of Hoeschle-Zeledon et al. 2013 (Hoeschle-Zeledon, I., P. Neuenschwander and L. Kumar. (2013). Regulatory Challenges for biological control. SP-IPM Secretariat, International Institute of Tropical Agriculture (IITA), Ibadan, Nigeria. 43 pp.), each of which is incorporated herein in its entirety.

In some embodiments, the biological is a Plant-Incorporated-Protectant (PIP). PIPs are pesticidal substances produced by genetically engineered plants. For example, in some embodiments, a plant is engineered to produce one or more of the pesticidal Cry or VIP proteins from Bacillus thuringiensis.

As used herein, “transgenic insecticidal trait” refers to a trait exhibited by a plant that has been genetically engineered to express a nucleic acid or polypeptide that is detrimental to one or more pests. In one embodiment, the plants of the present disclosure are resistant to attachment and/or infestation from any one or more of the pests of the present disclosure. In one embodiment, the trait comprises the expression of vegetative insecticidal proteins (VIPs) from Bacillus thuringiensis, lectins and proteinase inhibitors from plants, terpenoids, cholesterol oxidases from Streptomyces spp., insect chitinases and fungal chitinolytic enzymes, bacterial insecticidal proteins and early recognition resistance genes. In another embodiment, the trait comprises the expression of a Bacillus thuringiensis protein that is toxic to a pest. In one embodiment, the Bt protein is a Cry protein (crystal protein). Bt crops include Bt corn, Bt cotton and Bt soy. Bt toxins can be from the Cry family (see, for example, Crickmore et al., 1998, Microbiol. Mol. Biol. Rev. 62:807-812), which are particularly effective against Lepidoptera, Coleoptera and Diptera.

Bt Cry and Cyt toxins belong to a class of bacterial toxins known as pore-forming toxins (PFT) that are secreted as water-soluble proteins undergoing conformational changes in order to insert into, or to translocate across, cell membranes of their host. There are two main groups of PFT: (i) the α-helical toxins, in which α-helix regions form the trans-membrane pore, and (ii) the β-barrel toxins, that insert into the membrane by forming a β-barrel composed of βsheet hairpins from each monomer. See, Parker M W, Feil S C, “Pore-forming protein toxins: from structure to function,” Prog. Biophys. Mol. Biol. 2005 May; 88 (1): 91-142. The first class of PFT includes toxins such as the colicins, exotoxin A, diphtheria toxin and also the Cry three-domain toxins. On the other hand, aerolysin, α-hemolysin, anthrax protective antigen, cholesterol-dependent toxins as the perfringolysin O and the Cyt toxins belong to the β-barrel toxins. Id. In general, PFT producing-bacteria secrete their toxins and these toxins interact with specific receptors located on the host cell surface. In most cases, PFT are activated by host proteases after receptor binding inducing the formation of an oligomeric structure that is insertion competent. Finally, membrane insertion is triggered, in most cases, by a decrease in pH that induces a molten globule state of the protein. Id.

The development of transgenic crops that produce Bt Cry proteins has allowed the substitution of chemical insecticides by environmentally friendly alternatives. In transgenic plants the Cry toxin is produced continuously, protecting the toxin from degradation and making it reachable to chewing and boring insects. Cry protein production in plants has been improved by engineering cry genes with a plant biased codon usage, by removal of putative splicing signal sequences and deletion of the carboxy-terminal region of the protoxin. See, Schuler T H, et al., “Insect-resistant transgenic plants,” Trends Biotechnol. 1998; 16:168-175. The use of insect resistant crops has diminished considerably the use of chemical pesticides in areas where these transgenic crops are planted. See, Qaim M, Zilberman D, “Yield effects of genetically modified crops in developing countries,” Science. 2003 Feb. 7; 299 (5608): 900-2.

In some embodiments, the plant is engineered to express a protein selected from 8-endotoxins including but not limited to: the Cry1, Cry2, Cry3, Cry4, Cry5, Cry6, Cry7, Cry8, Cry9, Cry10, Cry11, Cry12, Cry13, Cry14, Cry15, Cry16, Cry17, Cry18, Cry 19, Cry20, Cry21, Cry22, Cry23, Cry24, Cry25, Cry26, Cry27, Cry 28, Cry 29, Cry 30, Cry31, Cry32, Cry33, Cry34, Cry35, Cry36, Cry37, Cry38, Cry39, Cry40, Cry41, Cry42, Cry43, Cry44, Cry45, Cry 46, Cry47, Cry49, Cry 51, Cry52, Cry 53, Cry 54, Cry55, Cry56, Cry57, Cry58, Cry59. Cry60, Cry61, Cry62, Cry63, Cry64, Cry65, Cry66, Cry67, Cry68, Cry69, Cry70 and Cry71 classes of 8-endotoxin genes and the B. thuringiensis cytolytic cyt1 and cyt2 genes.

### Biofertilizers

In some embodiments, the biological comprises a biofertilizer Biofertilizers are microorganisms, such as bacteria, fungi, and algae, that provide plants with nutrients, or help them to absorb nutrients, thus improving plant yield. Types of biofertilizers include, but are not limited to, microbes that increase nitrogen fixation, microbes that increase phosphate solubilization, microbes that increase nutrient mobilization, plant growth-promoting microbes, and plant growth-regulating microbes.

In some embodiments, the biological is a biofertilizer selected from the group consisting of a bacterial, algal, and fungal biofertilizer. In some embodiments, the biological is a biofertilizer that comprises at least one of a nitrogen fixer, a phosphate solubilizer, a nutrient mobilizer, plant growth-promoting bacteria, and plant growth-regulating bacteria.

In some embodiments, the biological comprises one or more species of cultured microbe selected from Methylobacterium, mycorrhizal fungi, Gluconacetobacter, Achromobacter, Agrobacterium, Anabaena, Azorhizobium, Azospirillum, Azotobacter, Bacillus, Beauveria, Bradyrhizobium, Clostridium, Enterobacter, Klebsiella, Kluyvera, Kosakonia, Mesorhizobium, Microbacterium, Ochrobactrum, Pantoea, Penicillium, Pseudomonas, Rahnella, Rhizoctonia, Rhizobium, Rhodopseudomonas, Sinorhizobium, Trichoderma, and combinations thereof.

In some embodiments, the biological comprises plant growth-promoting fungi and/or plant growth-promoting bacteria.

### Plant Growth-Promoting Fungi (PGPF)

PGPF species are beneficial to plants in several ways. For example, they can solubilize and mineralize nutrients making them accessible to plants; they regulate hormones; they produce compounds that suppress plant pathogens and alleviate abiotic stressors. In some embodiments, the biological comprises PGPF species of the genera Aspergillus, Penicillium, Phoma, Fusarium, Trichoderma, Piriforma, and Glomus.

### Aspergillus

In some embodiments, the biological comprises an Aspergillus species. Species of the fungi Aspergillus can protect plants and promote plant growth via production of pytases, auxins, gibberellins, and many secondary metabolites. The phytases for example, aid in phosphate solubilization. Some species of Aspergillus also are antagonist to plant pathogens (see for example, Nayak S. et al., (2020). Beneficial Role of Aspergillus sp. in Agricultural Soil and Environment, Frontiers in Soil and Environmental Microbiology (pp. 17-36)). Species of Aspergillus that have plant beneficial activity that may be included with the compositions, methods, kits, and systems disclosed herein. In some embodiments, the biological comprises a species of Aspergillus selected from, but not limited to, A. aculeatus, A. brasiliensis, A. clavatus, A. flavus, A. fumigatus, A. mellus, A. niger, A. nidulans, A. oryzae, A. sydowii, A. terreus, A. tubingensis, A. ustus, and A. sp. versicolor.

### Penicillium

In some embodiments, the biological comprises a Penicillium species. Many species of Penicillium have positive interactions with plants and can promote plant growth by supplying soluble phosphorus, indole-3-acetic acid, and gibberellic acid, and can also provide protection by acting as an antagonist to pathogens and/or activating plant defense signaling, and tolerance to abiotic stressors related to temperature, heavy metals, salt, and water. In some embodiments, the biological comprises a species of Penicillium selected from, but not limited to, P. bilaiae. P. brevicompactum, P. brocae, P. canescens, P. cecidicola, P. citrinum, P. coffeae, P. commune, P. crustosum, P. funiculosum, P. janthinellum, P. monteilii, P. olsonii, P. oxalicum, P. radicum, P. ruqueforti, P. sclerotiorum, P. simplicissimum, and P. steckii

### Trichoderma

In some embodiments, the biological comprises a Trichoderma species. Species of Trichoderma are present in soils all over the world. They have been shown to form mutualistic relationships with several plant species, regulating the rate of plant growth and suppressing the growth of plant pathogens through competition, antibiotic production, and chitinase secretion. The fungi further secrets organic acids that solubilize phosphates and mineral ions, such as iron, magnesium, and manganese. In some embodiments, the biological comprises a species of Trichoderma selected from, but not limited to, T. harzianum, T. atroviride, T. asperellum, T. virens, T. longipile, T. tomentosum, T. viride, T. afroharzianum, and T. hamatum.

### Mycorrhizal Fungi and Glomus

In some embodiments, the biological comprises a mycorrhizal fungi. Mycorrhizal fungi enhance plant access to soil nutrients and water. There are two functional types, arbuscular mycorrhizal fungi (AMF) and ectomycorrhizal fungi (EMF) which partner with plants having different nutrient acquisition strategies (for example, fast N cycling vs. slow N cycling). An example genus of AMF is Glomus. In some embodiments, the biological is a mycorrhizal fungi selected from Glomus intraradices, Glomus mosseae, Glomus aggregatum, Glomus etunicatum, Glomus clarus, and Rhizophagus intraradices.

### Plant Growth-Promoting Rhizobacteria (PGPR)

In some embodiments, the biological comprises a PGPR. PGPR species promote plant growth via direct mechanisms (for example, by improving nutrient acquisition and regulating phytohormones) and indirect mechanisms (for example, by inducing resistance to stressors or competing with a pathogen). In some embodiments, the biological comprises a PGPR species selected from the genera of Acinetobacter, Aeromonas, Agrobacterium, Allorhizobium, Arthrobacter, Azoarcus, Azorhizobium, Azospirillum, Azotobacter, Bacillus, Bradyrhizobium, Burkholderia, Caulobacter, Chromobacterium, Delftia, Enterobacter, Flavobacterium, Frankia, Gluconacetobacter, Klebsiella, Mesorhizobium, Methylobacterium, Micrococcus, Paenibacillus, Pantoea, Pseudomonas, Rhizobium, Serratia, Streptomyces, and Thiobacillus.

### Azospirillum

In some embodiments, the biological comprises an Azospirillum species. Azospirillum species have been shown to increase the yield, drought tolerance, and salt tolerance of crops such as corn, wheat, rice, and sugarcane (see for example G. F. Vogel, et al., Agronomic performance of Azospirillum brasilense on wheat crops, Appl. Res. Agrotechnol., 6 (2013), pp. 111-119; J. E. Garcia, et al., In vitro PGPR properties and osmotic tolerance of different Azospirillum native strains and their effects on growth of maize under drought stress, Microbiological Research 202 (2017) pp 21-29). Axospirillum further promotes plant growth through production of auxins, cytokinins, and gibberellins. In some embodiments, the biological comprises a species of Azospirillum selected from A. brasilense, A. amazonense, A. irakense, A. lipoferum, A. largimobile, A. halopraeferens, A. oryzae, A. canadensis, A. doebereinerae, and A. melinis

### Pseudomonas

In some embodiments, the biological comprises a Pseudomonas species. Pseudomonas species are present in both the rhizosphere as well as the within plant tissues. They have been extensively studied for their roles in plant growth promotion, control of pests and pathogens, and nutrient solubilization (Kumar A., et al., Role of Pseudomonas sp. in Sustainable Agriculture and Disease Management, (2017) pp 195-215). In some embodiments, the biological comprises a species of Pseudomonas selected from P. aeruginosa, P. aureofaciens, P. cepacia (formerly known as Burkholderia cepacia), P. chlororaphis, P. corrugata, P. fluorescens, P. proradix, P. putida, P. rhodesiae, P. syringae, P. protegens, P. chlororaphis, P. segetis, and P. segetis strain P6.

### Bacillus

In some embodiments, the biological comprises a Bacillus species. Bacillus is a diverse group of bacteria in the soil ecosystem, playing roles in nutrient cycling and imparting plant beneficial traits such as stress tolerance (see for example A. K. Saxena et al., “Bacillus species in soil as a natural resource for plant health and nutrition.” 2019. J of App. Microbiology, 128 (5): 1583-1594). In some embodiments, the biological comprises a species of Bacillus selected from B. subtilis, B. velezensis, B. siamensis, B. cereus, B. thuringiensis, Bacillus thuringiensis (var. kurstaki), B. thuringiensis subsp. israelensis, B. thuringiensis subsp. tenebrionis strain SA-10, B. thuringiensis subsp. aizawai, Bacillus thuringiensis strain VBTS 2528, B. licheniformis, B. pumilus, Bacillus pumilus strain QST 2808, B. altitudinis, B. stratosphericus, B. aerius, B. safensis, B. australimaris, B. amyloliquefaciens, B. methylotrophicus, B. megaterium, B. simplex, B. sp. AQ175 (ATCC Accession No. 55608), B. sp. AQ 177 (ATCC Accession No. 55609), B. sp. AQ178 (ATCC Accession No. 53522), B. sphaericus, B. bombysepticus, B. firmus, B. coagulans, B. azotofixans, and B. macerans.

In some embodiments, the biological comprises a soil inoculant comprising Bacillus sp. In some embodiments, the soil inoculant comprises species of Bacillus. In some embodiments, the biological comprises B. subtilis, B. pumilus, B. amyloliquefaciens, B. licheniformis, Paenibacillus chitinolyticus and/or B. laterosporus.

### Methylobacterium

In some embodiments, the biological comprises a Methylobacterium species. Methylobacterium are a genus of non-pathogenic bacteria found in a wide range of environments. A number of species of Methylobacterium have been shown to promote plant growth through their production of plant hormones such as cytokinins, abscisic acid, and indole-3-acetic acid. Of note, they are able to produce high levels of cytokinins and the active trans-Zeatin form (see for example, Palberg, D., et al. A survey of Methylobacterium species and strains reveals widespread production and varying profiles of cytokinin phytohormones. BMC Microbiol 22, 49 (2022)). In some embodiments, the biological comprises a species of Methylobacterium selected from M. gregans, M. adhaesivum, M. aerolatum, M. ajmalii, M. aquaticum, M. aminovorans, M. brachiatum, M. brachythecii, M. bullatum, M. cerastii, M. crusticola, M. currus, M. dankookense, M. durans, M. extorquens, M. frigidaeris, M. fujisawaense, M. funariae, M. gnaphalii, M. goesingense, M. gossipicola, M. haplocladii, M. hispanicum, M. indicum, M. iners, M. isbiliense, M. jeotgali, M. komagatae, M. longum, M. marchantiae, M. mesophylicum, M. nodulans, M. nonmethylotrophicum, M. organophillum, M. oryzae, M. oryzihabitans, M. oxalidis, M. persicinum, M. phyllosphaerae, M. phyllostachyos, M. planium, M. platani, M. pseudosasicola, M. radiotolerans corrig., M. rhodinum, M. segetis, M. soli, M. symbioticum, M. tardum, M. tarhaniae, M. terrae, M. terricola, M. thuringiense, M. trifolii, M. thiyocyanatum, M. variabile, M. zatmanii.

### Gluconacetobacter

In some embodiments, the biological comprises a Gluconacetobacter species. Species of Gluconacetobacter can establish symbiotic relationships with plants and promote growth and nitrogen fixation. In some embodiments, the biological comprises a species of Gluconacetobacter selected from G. azotocaptans, G. diazotrophicus, G. johannae, and G. sacchari

### Pantoea

In some embodiments, the biological comprises a Pantoea sp. In some embodiments, the biological comprises a species of Pantoea selected from Pantoea agglomerans, Pantoea agglomerans strain C9-1, Pantoea agglomerans strains (ATCC 27155, CCUG 539, CDC 1461-67, CFBP 3845, CIP 57.51, DSM 3493, ICPB 3435, ICMP 12534, JCM 1236, LMG 1286, NCTC 9381), Pantoea allii, Pantoea ananatis, Pantoea anthophila, Pantoea citrea, Pantoea deleyi, Pantoea dispersa, Pantoea eucalypti, Pantoea punctata, Pantoea stewartii, Pantoea terrea, and Pantoea vagans.

### Probelte® Biologicals

In some embodiments, the biological is a product from Probelte®. In some embodiments, the biological is an Agrobiotech product from Probelte®. In some embodiments, the biological is Biopron™ Premium, Bøtrybël™, Bulhnova™, Nemapron™, Strongest™, Belthirul™, Belthirul™ F, Belthirul™ S, Belthirul™ 16 SC, or Lepiback™. In some embodiments, the biological is a product listed in the product catalog of Probelte®, which can be retrieved from the world wide web at: probelte.com/wp-content/uploads/2022/02/Probelte_Product_catalogue.pdf. In some embodiments, the biological is Bøtrybël™. In some embodiments, the biological comprises Bacillus amyloliquefaciens. In some embodiments, the biological comprises 10⁸ CFU/mL Bacillus amyloliquefaciens. In some embodiments, the biological is for administration at a dose of 12-15 cc/L as a foliar application every 7-14 days. In some embodiments, the biological is for administration at 5-15 L/ha, 1-5 times. For example, in some embodiments, the biological is for administration 5-7 days after transplanting, 30-40 days after first application, and 50-60 days after first application.

In some embodiments, the biological is a Probelte® product, and it is administered in conjunction with a jasmonate disclosed herein, and it is for administration at the recommended dose according to its product packaging or labeling. In some embodiments, the Probelte® product is administered separately from a jasmonate composition disclosed herein. In some embodiments, the Probelte® product is administered in combination with a jasmonate composition disclosed herein.

In some embodiments, the biological is a composition or microbial strain disclosed in any one of WO-2008113873-A1, WO-2009013596-A2, WO-2009031023-A2, WO-2011036316-A2, WO-2011121408-A1, WO-2008090460-A1, WO-2009027544-A1, WO-2010041096-A1, or WO-2020216978-A1, each of which is incorporated by reference herein in its entirety.

### Impello® Biologicals

In some embodiments, the biological is an Impello® product. In some embodiments, the biological is a microbial inoculant, biostimulating additive, or nutrient product from Impello®. In some embodiments, the product is Biofuel™, Continuum™, Dune™, Lumina™, Tribus®, or Tundra™. In some embodiments, the product is any of the products available from Impello, a list of which can be retrieved from the world wide web at: impellobio.com/collections/all.

In some embodiments, the biological comprises microbial soil inoculants. In some embodiments, the biological comprises species of B. subtilis, B. pumilus, B. amyloliquefaciens, B. licheniformis, Paenibacillus chitinolyticus and/or B. laterosporus. In some embodiments, the biological comprises species of B. subtilis, B. pumilus, B. amyloliquefaciens, and/or Paenibacillus chitinolyticus. In some embodiments, the biological comprises a commercially available soil inoculant. in some embodiments, the biological comprises Tribus® or Continuum™. In some embodiments, the biological comprises Bacillus subtillis (e.g., at about 4.0×10⁹ CFU/ml), Bacillus pumilus (e.g., at about 4.0×10⁹ CFU/ml), and Bacillus amyloliquefaciens (e.g., at about 2.0×10⁹ CFU/ml). In some embodiments, the biological comprises Paenibacillus chitinolyticus (e.g., at about 10⁶ CFU/mL), Bacillus subtillis (e.g., at about 10⁶ CFU/mL), Bacillus pumilus (e.g., at about 10⁶ CFU/mL), and Bacillus amyloliquefaciens (e.g., at about 10⁶ CFU/mL).

### Formulations

The compositions disclosed herein include liquid and/or dry forms and include dry stock components that are added to water or other liquids prior to application to the plant in an aqueous form. Liquid compositions include aqueous, polar, or non-polar solutions. The compositions may comprise an oil-in-water emulsion or a water-in-oil emulsion. In some embodiments, the composition is diluted. In some embodiments the composition is concentrated. In some embodiments the composition is aqueous.

### Additional Ingredients

In some aspects, the composition comprises at least one carrier/solvent, and/or at least one adjuvant. In some aspects, the at least one adjuvant is selected from the group consisting of emulsifiers, spreaders, binders, penetrants, safeners, anticaking agents, and any mixture thereof.

In some embodiments, the composition comprises a carrier. Non-limiting examples of conventional carriers include liquid carriers, including aerosol propellants which are gaseous at normal temperatures and pressures, such as Freon; inert dispersible liquid diluent carriers, including inert organic solvents, such as aromatic hydrocarbons (e.g., benzene, toluene, xylene, alkyl naphthalenes), halogenated especially chlorinated, aromatic hydrocarbons (e.g., chloro-benzenes), cycloalkanes (e.g., cyclohexane), paraffins (e.g., petroleum or mineral oil fractions), chlorinated aliphatic hydrocarbons (e.g., methylene chloride, chloroethylenes), alcohols (e.g., methanol, ethanol, propanol, butanol, glycol), as well as ethers and esters thereof (e.g., glycol monomethyl ether), amines (e.g., ethanolamine), amides (e.g., dimethyl sormamide), sulfoxides (e.g., dimethyl sulfoxide), acetonitrile, ketones (e.g., acetone, methyl ethyl ketone, methyl isobutyl ketone, cyclohexanone), and/or water; as well as inert dispersible finely divided solid carriers such as ground natural minerals (e.g., kaolins, clays, vermiculite, alumina, silica, chalk, i.e., calcium carbonate, talc, attapulgite, montmorillonite, kieselguhr), and ground synthetic minerals (e.g., highly dispersed silicic acid, silicates). More non-limiting examples of suitable carriers/solvents include, but are not limited to, Isopar™ M, THEA™, ethyl lactate, butyl lactate, Soygold™ 1000, M-Pyrol, Propylene glycol, Agsolex™ 12, Agsolex™ BLO, Light mineral oil, Polysolve™ TPM, and Finsolv™ TN. In one embodiment, the solvent in said composition of present disclosure can be organic solvent, e.g. petroleum distillates or hydrocarbons. In some embodiments, the concentration of solvent in the composition of present disclosure is about 0%, at least about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 99%, by weight.

In some embodiments, the composition comprises a spreader and/or sticking agent. Non-limiting examples of suitable spreaders and/or sticking agents include, but are not limited to, Latex emulsion, Umbrella™, Adsee™ 775, Witconol™ 14, Toximul™ 858, Latron™ B-1956®, Latron™ CS-7®, Latron™ AG-44M, T-Mulz™ AO-2, T-Mulz™ 1204, Silwet™ L-774, SUSTAIN® (Western Farm Service, Inc.), Pinetac® (Britz Fertilizers, Inc.), Nufilm PR (Miller Chemical & Fertilizer Corporation), Nufilm 17® (Miller Chemical & Fertilizer Corporation), Sufrix®, Cohere®, Induce®, Picclyte®, Peg600 Argimax 3H®, and PEG 600ML®.

In some embodiments, the composition comprises a surface-active agent. Non-limiting examples of surface-active agents include, but are not limited to, emulsifying agents, such as non-ionic and/or anionic emulsifying agents (e.g., polyethylene oxide esters of fatty acids, polyethylene oxide ethers of fatty alcohols, alkyl sulfates, alkyl sulfonates, aryl sulfonates, albumin-hydrolyzates, and especially alkyl arylpolyglycol ethers, magnesium stearate, sodium oleate); and/or dispersing agents such as lignin, sulfite waste liquors, methyl cellulose.

In some embodiments, the composition comprises an emulsifier. Examples of commercial anionic emulsifiers that can be used include, but are not limited to: Rhodacal™ DS-10, Cafax™ DB-45, Stepanol™ DEA, Aerosol™ OT-75, Rhodacal™ A246L, Rhodafac™ RE-610, Rhodapex™ CO-433, Rhodapex™ CO-436, Rhodacal™ CA, Stepanol™ WAC. Examples of commercial non-ionic emulsifiers that can be used include, but are not limited to: Igepal™ CO-887, Macol™ NP-9.5, Igepal™ CO-430, Rhodasurf™ ON-870, Alkamuls™ EL-719, AlkamulsTMEL-620, Alkamide™ L9DE, Span™ 80, Tergitol™ TMN-3, Tergitol™ TMN-6, Tergitol™ TMN-10, Morwet™ D425, Tween™ 80, Alkamuls™ PSMO-5, Atlas™ G1086, Tween™ 20, Igepal™ CA-630, Toximul™ R, Toximul™ S, Polystep™ A7, and Polystep™ B1. In some embodiments, the emulsifier in the composition of present disclosure is Tween™. In another embodiment, the emulsifier is Tween™-20. In some embodiments, the disclosure provides compositions comprising a jasmonate, a biological, and an emulsifier.

In some embodiments, the composition comprises a pesticide. In some embodiments, the composition is added to an existing pesticide (such as a fungicide) to increase efficacy. Example fungicides include, but are not limited to, azoxystrobin, bifujunzhi, coumethoxystrobin, coumoxystrobin; dimoxystrobin, enes-troburin, enoxastrobin, fenaminstrobin, fenoxystrobin, flufenoxystrobin, fluoxastrobin, jiaxiangjunzhi, kresoxim-methyl, mandestrobin, metominostrobin, orysastrobin, picoxystrobin, pyraclostrobin, pyrametostrobin, pyraoxystrobin, triclopyricarb, trifloxystrobin, methyl 2-[2-(2,5-dimethylphenyloxymethyl)phenyl]-3-methoxyacrylate, pyribencarb, triclopyricarb/chlorodincarb, famoxadon, fena-midon, cyazofamid, amisulbrom, benodanil, bixafen, boscalid, carboxin, fenfuram, fluopyram, flutolanil, fluxapyroxad, furametpyr, isopyrazam, mepronil, oxycarboxin, penflufen, penthiopyrad, sedaxane, tecloftalam, thifluzamide, N-(4′-trifluoromethylthiobiphenyl-2-yl)-3-difluoromethyl-1-methy 1-1H-pyrazole-4-carboxamide, N-(2-(1,3,3-trimethylbutyl)phenyl)-1,3-dimethyl-5-fluoro-1H-pyrazole-4-carboxamide, N-[9-(dichloromethylene)-1,2,3,4-tetrahydro-1,4-methanonaphthalen-5-yl]-3-(difluoromethyl)-1-methyl-H-pyrazole-4-carboxamide, diflumetorim, binapacryl, dinobuton, dinocap, meptyl-dinocap, fluazinam, ferimzone, ametoctradin, silthiofam, azaconazole, bitertanol, bromuconazole, cyproconazole, difenoconazole, diniconazole, diniconazole-M, epoxiconazole; fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole, imazalil, pefurazoate, prochloraz, triflumizole, pyrimidines, fenarimol, nuarimol, pyrifenox, triforine, aldimorph, dodemorph, dodemorph acetate, fenpropimorph, tridemorph, fenpropidin, piperalin, spiroxamine, fenhexamid, benalaxyl, benalaxyl-M, kiralaxyl; metalaxyl, metalaxyl-M (mefenoxam), ofurace; oxadixyl, hymexazole, octhilinone, oxolinic acid, bupirimate, benomyl, carbendazim, fuberidazole, thiabendazole, thiophanate-methyl, 5-chloro-7-(4-methyl-piperidin-1-yl)-6-(2,4,6-trifluorophenyl)-[1,2,4]triazolo[1,5-a]pyrimidine, diethofencarb, ethaboxam, pencycuron, fluopicolid, zoxainid, metrafenon, pyriofenon, cyprodinil, mepanipyrim, pyrimethanil, fluoroimide, iprodione, procymidone, vinclozolin fenpiclonil, fludioxonil, quinoxyfen, edifenphos, iprobenfos, pyrazophos, isoprothiolane, dicloran, quintozene, tecnazene, tolclofos-methyl, biphenyl, chloroneb, etridiazole, dimethomorph, flumorph, mandipropamid, pyrimorph, benthiavalicarb, iprovalicarb, valifenalate and 4-fluorophenyl N-(1-(1-(4-cyanophenyl)ethanesulfonyl)but-2-yl)carbamate, propamocarb, propamocarb hydrochloride, ferbam, mancozeb, maneb, metiram, propineb, thiram, zineb, ziram, anilazine, chlorothalonil, captafol, captan, folpet, dichlofluanid, dichlorophen, flusulfamide, hexachlorobenzene, pentachlorophenol, phthalid, tolylfluanid, N-(4-chloro-2-nitrophenyl)-N-ethyl-4-methyl-benzenesulfonamide, guanidine, dithianon, validamycin, polyoxin B, pyroquilon, tricyclazole, carpropamid, dicyclomet, fenoxanil, and mixtures thereof.

### Pesticides and Repellents

In some embodiments, a composition herein comprises an insect repellent. An insect repellent is generally different from an insecticide, in that a repellent is a substance applied to surfaces of a plant or soil which discourages insects from landing, climbing, or feeding on the plant, while an insecticide is a pesticide used against insects by killing, damaging, or inhibiting growth after they have made contact with the plant. For example, pymetrozine or flonicamid/Beleaf are categorized as insecticides since they act directly on the insect to disrupt its physiology and prevent feeding. In some cases, insecticides can even worsen virus transmission since the insects, e.g., aphids, keep probing and trying to feed.

### Methods of Prophylactic Plant Protection

The present disclosure provides methods of preventing and/or reducing plant damage caused by plant pests and/or pathogens. The methods comprise applying a composition of the disclosure. In some embodiments, the methods comprise applying a jasmonate composition of the disclosure. In some embodiments, the methods comprise applying a jasmonate and a biological of the disclosure.

Insects are one of the ways pathogens are transmitted to plants. They can also cause severe damage to plants, resulting in devastating crop losses. In some embodiments, the present disclosure provides methods of using a jasmonate, or a composition comprising at least one jasmonate, to increase a plant's endogenous defense compounds in such a way that the plant is already unfavorable to insects that may enter the field or greenhouse during the growing season, thus reducing or eliminating crop damage and pathogen transmission by pests. In some cases, the jasmonate itself acts as a deterrent to the pest or pathogen, and thus can also be used as a treatment for an infestation. In some embodiments, the methods comprise applying a jasmonate and a biological.

### Application

The biologicals and jasmonates described herein can be applied in a number of different ways. For small scale application of a liquid composition, backpack tanks, hand-held wands, spray bottles, or aerosol cans can be utilized. For larger scale application of liquid compositions, tractor drawn rigs with booms, tractor drawn mist blowers, airplanes or helicopters equipped for spraying, or fogging sprayers can all be utilized.

Under certain conditions, a liquid composition can be injected or otherwise applied into the soil below the surface. In this manner, the methods and compositions of the present disclosure can be used to inhibit, prevent or repel soil insects from contacting plants and/or feeding on plants. For example, corn root worms in the soil from contacting and/or feeding on plants. One common method of injecting such liquids into the soil is to provide a sharpened point on the lower end of a shank and a tube extending down the shank behind the point. As the point is moved forwardly through the soil, it opens a furrow and liquid conducted downwardly through the tube soaks into the soil in the furrow. This arrangement does not disperse the liquid laterally into the soil and the liquid is concentrated in a narrow band.

The biologicals and jasmonates described herein can be delivered through an irrigation system. Irrigation is an artificial application of water to the soil. It is usually used to assist in growing crops in dry areas and during periods of inadequate rainfall. Additionally, irrigation also has a few other uses in crop production, which include protecting plants against frost, suppressing weed growing in rice fields and helping in preventing soil consolidation. Commonly used irrigation techniques include, but are not limited to, surface irrigation, localized irrigation, drip irrigation, sprinkler irrigation, center pivot irrigation, sub irrigation (seepage irrigation), manual irrigation using buckets or watering cans, automatic, non-electric irrigation using buckets and ropes, irrigation using stones to catch water from humid air, and irrigation with dry terraces.

The biologicals and jasmonates described herein can be applied to any plant or any plant part grown in any type of media (e.g., soil, vermiculite, shredded cardboard, water).

The biologicals and jasmonates described herein may be applied any time during the life cycle of a plant, during one or more stages of a plant's life cycle, or at regular intervals of a plant's life cycle, or continuously throughout the life of the plant. By applying the biologicals and jasmonates described herein before insect populations reach the economic threshold for a particular insect and plant species combination, the preventative, inhibitory and/or repelling effect of the compositions can be maintained for as long as desirable by repeated applications.

For example, in some aspects the biologicals and jasmonates described herein can be applied before, during and/or shortly after the plants are transplanted from one location to another, such as from a greenhouse or hotbed to the field. In another aspect, the biologicals and jasmonates described herein can be applied shortly after seedlings emerge from the soil or other growth media (e.g., vermiculite).

In some embodiments, the biological and jasmonate are administered simultaneously. In some embodiments, the biological and jasmonate are comprised by the same composition and are simultaneously applied. In some embodiments, the biological and jasmonate are comprised by separate compositions, but are applied at the same time, i.e., less than one hour apart.

In some embodiments, the biological is applied before the jasmonate. In some embodiments, the biological is applied about 1, 2, 3, 4, 5, 6, 7, 8, 9, 10, 11, 12, 13, 14, 15, 16, 17, 18, 19, 20, 21, 22, 23, or 24 hours before the jasmonate. In some embodiments, the biological is applied about 1, 2, 3, 4, 5, 6, 7, 8, 9, 10, 11, 12, 13, or 14 days before the jasmonate. In some embodiments, the biological is applied about 1, 2, 3, 4, 5, 6, 7, or 8 weeks before the jasmonate. In some embodiments, the biological is applied about 1, 2, or 3 months before the jasmonate.

In some embodiments, the biological is applied after the jasmonate. In some embodiments, the biological is applied about 1, 2, 3, 4, 5, 6, 7, 8, 9, 10, 11, 12, 13, 14, 15, 16, 17, 18, 19, 20, 21, 22, 23, or 24 hours after the jasmonate. In some embodiments, the biological is applied about 1, 2, 3, 4, 5, 6, 7, 8, 9, 10, 11, 12, 13, or 14 days after the jasmonate. In some embodiments, the biological is applied about 1, 2, 3, 4, 5, 6, 7, or 8 weeks after the jasmonate. In some embodiments, the biological is applied about 1, 2, or 3 months after the jasmonate.

According to the methods of the present disclosure the biologicals and jasmonates described herein can be applied at any desirable time before the pests reach an economic threshold.

In some embodiments, pests are repelled, inhibited, or prevented from contacting plants for at least 1 day after application. In some aspects, pests are repelled, inhibited, or prevented from contacting plants for at least 2 days after application. In some aspects, pests are repelled, inhibited, or prevented from contacting plants for at least 3 days after application. In some aspects, pests are repelled, inhibited, or prevented from contacting plants for at least 1 week after application. In some aspects, pests are repelled, inhibited, or prevented from contacting plants for more than 1 week after application (e.g., for at least 8 days, or at least 9 days, or at least 10 days or at least 11 days, or longer).

### Illustrative Jasmonate Modes of Application and Rates of Application

In some aspects, the method comprises applying an effective amount of a jasmonate composition disclosed herein. In some embodiments, the composition may be prepared as a concentrate for industrial application and further dilution or as a fully diluted ready-to-apply composition. For example, a ready-to-apply composition may comprise between 1 mM and 10 mM jasmonate and the effective rate may be an application of between 25 and 75 gallons per acre in a field setting. In some aspects, the effective rate is about 50 gallons per acre in a field setting. In some aspects, the composition may comprise about 1 mM, 2 mM, 3 mM, 4 mM, 5 mM, 6 mM, 7 mM, 8 mM, 9 mM or 10 mM of at least one jasmonate. In some aspects, the composition may comprise between about 1-2 mM, between about 2-3 mM, between about 3-4 mM, between about 4-5 mM, between about 5-6 mM, between about 6-7 mM, between about 7-8 mM, between about 8-9 mM, or between about 9-10 mM of a jasmonate, and the effective amount may be a spray-to-drip foliar spray. In some embodiments, the effective amount of the jasmonate is between 350-850 ppm applied at a rate of 50 gallons per acre. In some embodiments, the effective amount of the jasmonate is between 850-1700 ppm applied at an application rate of 100 gallons per acre. In some embodiments, the effective amount of the jasmonate is application of a 250 ml of a composition comprising between 1 mM and 10 mM jasmonate to the roots or soil surrounding the plant.

In some embodiments, the effective amount is a foliar spray of a composition comprising between 1 mM and 10 mM of a jasmonate applied at an application rate of approximately 5-6 ounces per plant. In some cases, the application rate is approximately 4-5 ounces per plant. In some cases, the application rate is approximately 3-4 ounces per plant. In some cases, the application rate is approximately 2-3 ounces per plant. In some cases, the application rate is approximately 1-2 ounces per plant. In some cases, the application rate is approximately 0.1-1 ounce per plant.

In some embodiments, the effective amount is a root drench of a composition comprising between 1 mM and 10 mM of a jasmonate applied at an application rate of approximately 150 ml to 500 ml per plant.

In some embodiments, a jasmonate of the disclosure is suitable for application directly to a pest or pathogen. In some embodiments, a jasmonate of the disclosure is suitable for application to a pest or pathogen in vitro for the reduction or treatment thereof.

### Illustrative Biological Modes and Rates of Application

In some embodiments, the methods herein comprise applying a jasmonate and a biological. In some aspects, the jasmonate or composition comprising a jasmonate and the biological are applied simultaneously. In some aspects, they are applied separately. For example, a biological comprising a soil inoculant comprising at least about 100 million colony forming units (CFU) per milliliter may be applied to the soil prior to, at the time of, or shortly after seeding, and the jasmonate or composition comprising the jasmonate may be applied to the same soil area or plant tissue during or after emergence. Applications of both may be reapplied at regular intervals throughout the grow season to maintain a disease suppressive microclimate.

In some embodiments, the biological comprises Bacillus subtillis (e.g., 4.0×10⁹ CFU/ml), Bacillus pumilus (e.g., 4.0×10⁹ CFU/ml), and Bacillus amyloliquefaciens (e.g., 2.0×10⁹ CFU/ml) and is applied at a rate of 1-2 quarts per 50 gallons of water per acre. In some embodiments, the composition is applied at an application rate of approximately 5-6 ounces per plant. In some cases, the application rate is approximately 4-5 ounces per plant. In some cases, the application rate is approximately 3-4 ounces per plant. In some cases, the application rate is approximately 2-3 ounces per plant. In some cases, the application rate is approximately 1-2 ounces per plant. In some cases, the application rate is approximately 0.1-1 ounce per plant. In some embodiments, the composition is applied as a root drench at an application rate of approximately 150 ml to 500 ml per plant.

In some embodiments, the biological is a product from Probelte®. In some embodiments, the biological is Bøtrybël™. In some embodiments, the biological comprises Bacillus amyloliquefaciens. In some embodiments, the biological comprises 10⁸ CFU/mL Bacillus amyloliquefaciens. In some embodiments, the biological is for administration at a dose of 10-20 cc/L as a foliar application. In some embodiments, the biological is for administration at a dose of 12-15 cc/L as a foliar application. In some embodiments, the foliar application is for administration every 7-14 days. In some embodiments, the biological is for administration at 2-20 L/ha as a drip irrigation. In some embodiments, the biological is for administration at 5-15 L/ha as a drip irrigation. In some embodiments, the drip irrigation is applied 1-5 times. For example, in some embodiments, the biological is for administration 5-7 days after transplanting, 30-40 days after first application, and 50-60 days after first application.

In some embodiments, the biological is a Probelte® product, it is administered in conjunction with a jasmonate disclosed herein, and it is for administration at the recommended dose according to its product packaging or labeling. In some embodiments, the Probelte® product is administered separately from a jasmonate composition disclosed herein. In some embodiments, the Probelte® product is administered in combination with a jasmonate composition disclosed herein.

### Reducing or Preventing Pest or Pathogen Induced Plant Damage

In some embodiments, the methods and compositions disclosed herein are used to treat, reduce, or prevent plant damage. In some embodiments, plant damage is measured in terms of progression of an infestation or infection. In some embodiments, plant damage is measured in terms of number or percentage of affected plant parts, e.g., leaves, branches, flowers, or fruits. In some embodiments, plant damage is measured in terms of decrease in harvestable plant parts, e.g., leaves, seeds, or fruits. In some embodiments, plant damage is measured in terms of productivity, yield, or other metrics of harvest.

In some embodiments, reduction of damage is measured via a reduction in number of infected leaves, percent of infected leaves, number of infected fruits, percent of infected fruits, number of dead leaves, percent of dead leaves, number of damaged leaves, percent of damaged leaves, number of damaged fruits, percent of damaged fruits, degree of infection, progression of infection, degree of infestation, or progression of infestation.

Insect repellents are generally applied to the plant before the emergence or appearance of insects, or after the emergence or appearance of insects but before the insect density reaches economic threshold, while insecticides are applied after the emergence or appearance of insects, after the insect density reaches the economic threshold for a particular insect species and a particular plant species. Biopesticides may be used as repellants or pesticides.

In some embodiments, the methods and compositions disclosed here are used as a repellent. In some embodiments, the methods and compositions disclosed here are used as a pesticide.

Economic thresholds may vary depending on insect species, plant species, plant part and/or plant developmental stage. For example, Table 3 shows a number of representative economic thresholds.

TABLE 3
Example Economic Thresholds

| | Plant Species/ | |
|---|---|---|
| Insect Species | Part | Recommended Economic Threshold |
| Hemp russett | Cannabis | To be determined |
| mite: Aculops | | |
| cannabicola | | |
| Corn ear worm: | | |
| Helicoverpa zea | | |
| Alfalfa weevil | Alfalfa/Hay | 25-50% of leaves on upper ⅓ of stem, or |
| | | 50-70% of foliage tips show injury |
| Corn leaf aphid | Cereals | 12-15 aphids/stem prior to soft dough |
| Russian wheat | Cereals | 10% of the plants infested with at least 1 aphid |
| aphid | | when first node visible 10% of the tillers |
| | | infested with 1 aphid when tip of flag leaf just |
| | | visible |
| Green bug | Cereals | 12-15 aphids/stem prior to soft dough |
| Potato aphid | Flax | 2-3 aphids/main stem at full bloom |
| | | Flax 8 aphids/main stem at green boll stage |
| Pea aphid | Peas | 2-3 aphids on top 20 cm of plant tip (Trapper |
| | | peas can withstand considerably higher levels) |
| | | main stem is considered to be the main yield |
| | | component of the plant (usually the primary |
| | | stem) |
| Thrips Barley | Oats | 7-8 thrips/stem prior to head emergence; |
| | | Red Clover 50-80 thrips per flower head |
| Beet Webworm | Canola | 20-30 larvae/m2; Flax >10 larvae/m2 |
| Clover cutworm | Canola | Mustard 20-30 larvae/m2; Flax Economic |
| | | thresholds not yet established but expected to |
| | | be lower than cereals |
| Cutworms | Cereals | 3-4 larvae/m2; Oilseeds Economic thresholds |
| | | not yet established but expected to be lower |
| | | than cereals |
| Diamondback | Canola | Mustard 100-150 larvae/m2 in immature and |
| moth | | flowering fields; 200-300 larvae/m2 in |
| | | podded canola fields |
| | | These threshold numbers are based on stands |
| | | averaging 150 to 200 plants/m2. In areas |
| | | where stands are thinner the economic |
| | | threshold should be lowered accordingly. |
| Grasshoppers | Cereals | 8-12 grasshoppers/m2 |
| Grasshoppers | Flax | Lentil 2 grasshoppers/m2-depending on crop |
| | | stage (i.e. lentil pods are far more prone to |
| | | attack than is the foliage) |
| Grasshoppers | Canola | >14 grasshoppers/m2 |
| Orange wheat | Wheat | 1 midge/4-5 wheat heads |
| blossom midge | | |
| Painted lady | Sunflowers | 25% defoliation |
| butterfly | | |
| Red sunflower | Sunflower Oil | 12-14 weevils/head at 85-100% bloom |
| seed weevil | crop | |
| Red sunflower | Confectionery | 1-2 weevils/head at 85-100% bloom |
| seed weevil | | |
| Red turnip beetle | Canola | As soon as beetles become numerous |
| Sunflower beetle | Sunflowers | 1 adult beetle/2-3 seedlings at the 2-6 leaf |
| | | stage or >10 larvae per plant during summer |
| Sunflower moth | Sunflowers | As soon as moths are present and > 10% of |
| | | blooms |
| Sweetclover | Clover | 1st year stands: 1 weevil/3 seedlings (⅕ |
| weevil | | seedlings under dry conditions); 2nd year |
| | | stands: 9-12 weevils/plant |

Additional recommended economic thresholds can be found in, for example, Lamb, et al. Agribinusts Conference, 2004, pp. 90-98; Ward, Australian Journal of Entomology (2005) 44, 310-315; Byrne et al. N. C. Toscano/Crop Protection 25 (2006) 831-834; Boica et al. Journal of Insect Science, 2008, vol. 8 pp. 8-9; Wright et al. Bulletin of Entomological Research, 2007 vol. 97, pp. 569-757; Meng et al. Journal of Biological Systems 2007, vol. 15, pp. 219-234; Wang et al. Yangzhou Daxue Xuebao Ziran Kexue Ban 2006, vol. 9, pp. 36-41; Dumbauld et al. Aquaculture, 2006 vol. 261, pp. 976-992; Ajeigbe et al. Crop Protection, 2006, vol. 25, pp. 920-925; Posey et al., Journal of Economic Entomology, 2006, vol. 99, pp. 966-971; Byme et al. Crop Protection, 2006, vol. 25 pp. 831-834; Bird et al. Bulletin of Entomological Research, 2006 vol. 96, pp. 15-23; Ward, Australian Journal of Entomology, 2005, vol. 44, pp. 310-315; Duffield, Australian Journal of Entomology, 2005, vol. 44, pp. 293-298; Bhattacharyya et al. Australian Journal of Entomology, 2005, vol. 98, pp. 814-820; Zou, et al. Environmental Entomology, 2004, vol. 33, pp. 1541-1548; Fettig et al. Journal of Arboriculture, 2005, vol. 31, pp. 38-47; Hori, Applied Entomology and Zoology, 2005, vol. 38, pp. 467-473; Prokopy, Agriculture Ecosystems & Environment, 2003, vol. 94, pp. 299-309; Agnello, Agriculture Ecosystems & Environment, 2003, vol. 94, pp. 183-195; Schuster, Journal of Economic Entomology, 2002, vol. 95, pp. 372-376; Harris et al. Calculating a static economic threshold and estimating economic losses for the pecan weevil, Southwestern Entomologist; Dent, Insect pest management published by CABI, 2000, Pimentel, Biological invasions Published by CRC Press, 2002; R. Cavalloro, Statistical and mathematical methods in population dynamics and pest control, Published by CRC Press, 1984; Metcalf et al., Introduction to insect pest management, William Henry Luckmann, Edition: 3, Published by Wiley-IEEE, 1994.

For some species of plant and pest there is no economic threshold established, for example, cannabis (both hemp and marijuana varieties). For others, it is an evolving value. For example, in California the navel orangeworm threshold has been 2 mummy nuts or fewer per tree, however new data supports a more stringent threshold of 0.2 mummies per tree (Higbee, B. et al., New navel orangeworm sanitation standards could reduce almond damage, Calif Ag 63(1):24-28 (2009)).

### Plant Insect Pests

Insects (Class Insecta) are the most diverse group of animals on the planet and comprise 80% of the world's species. In the U.S., there are 91,000 species of insect, including 30,000 species of beetle, 19,600 species of fly, 18,000 species of ants, bees, and wasps, and 11,750 species of moths and butterflies.

Almost all crops can be negatively affected by at least one pest, and may benefit from application of the biologics and jasmonates described herein. Example crops include, but not are not limited to, brassica leafy vegetables (e.g. broccoli, broccoli raab, Brussels sprouts, cabbage, Chinese cabbage (Bok Choy and Napa), cauliflower, cavalo, collards, kale, kohlrabi, mustard greens, rape greens, and other brassica leafy vegetable crops), bulb vegetables (e.g. garlic, leek, onion (dry bulb, green, and Welch), shallot, and other bulb vegetable crops), citrus fruits (e.g. grapefruit, lemon, lime, orange, tangerine, citrus hybrids, pummelo, and other citrus fruit crops), cucurbit vegetables (e.g. cucumber, citron melon, edible gourds, gherkin, muskmelons (including hybrids and/or cultivars of Cucumis melons), pumpkin, summer and winter squash, water-melon, cantaloupe, and other cucurbit vegetable crops), fruiting vegetables (including eggplant, ground cherry, pepino, pepper, tomato, tomatillo, and other fruiting vegetable crops), grape, leafy vegetables (e.g. lettuce, romaine), root/tuber and corm vegetables (e.g. potato), and tree nuts (almond, pecan, pistachio, and walnut).

Agricultural insect pests can be classified into chewing insects, sucking insects, and soil insects. Common chewing insects are, for example, beet armyworm (Spodoptera exigua), diamondback moth (Plutella xylostella), corn earworm (Heliothis zea, a.k.a. bollworm and tomato fruitworm), blister beetles (Epicauta and others), carrot weevils (Listronotus oregonensis, Hyperodes texana), cabbage looper (Trichopulsia ni), grasshopper (several species), flea beetles (e.g., tobacco fleabeetle (Epitrix hirtipennis), eggplant fleabeetle (E. fuscula), potato fleabeetle (E. cucumeri) and other species), fall armyworm (Spodoptera frugiperda), Lesser cornstalk borer (Elasmopalpus lignosellus), Texas leafcutting ant (Atta texana), citrus leafminer (Phyllocnistis citrella), leafminers (Liiriomyza spp.), yellowstriped armyworm (Spodoptera ornithogalli).

Common sucking insects are, for example, stink bugs (e.g. Nezara viridula and other species), sharpshooters (Homalodisca spp. and Oncopmetopia spp.), whiteflies (e.g. sliverleaf whitefly, greenhouse whitefly, sweetpotato whitefly (Bemisia tabaci)), greenhouse whitefly (Trialeuroides vaporariorum), psyllid (e.g. Asian citrus psyllid), squash bug (Anasa tristis), leaffooted bugs (Leptoglossus spp.), leafhoppers (e.g., bean leafhopper, Empoasca solana, aster leafhopper, Macrosteles fascifrons, western potato leafhopper, Empoasca abrupta, grape leafhopper, variegated leafhopper, beet leafhopper, Circulifer tenellus), aphids (Aphidoidea, e.g. green peach aphid, turnip aphid, melon aphid, potato aphid, rosy apple aphid, spirea aphid). Common rasping insects include, but are not limited to, thrips (e.g. citrus thrips, western flower thrips (Frankliniella occidentalis), onion thrips (Thrips tabaci), melon thrips, chili thrips).

Common soil insects are, for example, granulate cutworm (Feltia subterranea), mole crickets (e.g. northern mole cricket, Neocurtilla hexadactyla, southern molre cricket Scapteriscus acletus), corn rootworm (e.g. Diabrotica undecimpunctata howardi), pillbugs and sowbugs (several species), sweetpotato weevil (Cylas formicarius elegantulus), white grubs (Pyllophaga spp.), wireworms (several species).

Additionally, chewing and sucking insects are capable of transmitting viral diseases. The transmission may be simply mechanical or may be biological. In the latter case the specific insect and the specific viral pathogen have some kind of association or relationship. In such case, insects are called the “vector” for particular viral pathogen. In case of mechanical transmission the pathogen is simply carried externally or internally by insects. Virus carried biologically by insect vectors are of two types: non-persistent viral pathogen, wherein the viral pathogens require no latent or incubation period in the insect body, and persistent viral pathogen, wherein viral pathogens requiring certain incubation period inside the vector body before they are inoculated or transmitted to healthy host. The insects responsible for transmission of viral diseases are, for example, aphids, jassids (leaf hoppers), whiteflies, mealy bugs, etc. Certain bacterial and several fungal pathogens are also known to be carried by insects (Leach, Insect Transmission of Plant Disease, 2007, Daya Publishing House).

Mites, also known as ticks, belong to subclass Acarina (or Acari) and the class Arachnida. Many live freely in the soil or water, but there are also a large number of species that live as parasites on plants, animals, and some that feed on mold. Some of the plant mite parasites are spider mites (family Tetranychidae), thread-footed mites (family Tarsonemidae), and the gall mites (family Eriophyidae). For example, plant mite parasites include, but are not limited to, two-spotted spider mite (e.g., Tetranychus urticae, Tetranychus marianae, Oligonychus spp. and others species); Kanzawa spider mite (e.g., Tetranychus kanzawai); citrus red mite (e.g., Panonychus citri); European red mite (e.g., Panonychus ulmi), yellow spider mite (e.g., Eotetranychus carpini); Texas citrus mite (e.g., Eotetranychus banksi); citrus rust mite (e.g., Phyllocoptruta oleivora); broad mite (e.g., Polyphagotarsonemus latus); false spider mite (e.g., Brevipalpus sp.); bulb mite (e.g., Rhizoglyphus robini) and mold mite (e.g., Tyrophagus putrescentiae); strawberry spider mite; pacific mite; willamette spider mite; six-spotted spider mite; citrus red mite and citrus rust mite. More plant mite parasites can be found in Ellis et al. (Ellis et al., The organic gardener's handbook of natural insect and disease control, Published by Rodale, 1996).

### Pathogens

Plants that have been damaged by chewing pests are more susceptible to infection. Additionally, pests can act as vectors, transmitting plant pathogens through the wounds the insect makes. Almost all pathogenic viruses, some protozoa and some nematodes are transmitted by insects. Transmission can also be passive, as in the case of fungal spores on legs, mouthparts, and bodies.

For example, thrips can carry and spread Botrytis spores and infect plants with ‘gray mold.’ Botrytis cinerea is a necrotrophic and saprophytic fungus, killing both living and non-living organic matter to obtain the nutrients it needs to grow. Botrytis can infect over 200 plant species, but has been particularly detrimental to strawberry and grape. The striped cucumber beetle and spotted cucumber beetle transmit bacterial wilt in Cucurbitaceae species, depositing the bacterial via their feces in the wounds from their feeding. Other pathogens are likely aided in some form by insects, such as Fusarium and the European corn borer (corn), the eriophyid mite (mango), and the fig wasp (fig), etc. Transmission of plant pathogens by biological vectors such as insects is well known in the art (see for example, Agrios, G. “Transmission of Plant Diseases by Insects, University of Florida, available on the world wide web at entnemdept.ufl.edu/capinera/eny5236/pest1/content/03/3_plant_diseases.pdf).

In some embodiments, the methods and compositions disclosed herein prevent transmission of a plant pathogen by deterring plant pests.

In some embodiments, the present disclosure provides methods and compositions for preventing and/or treating a fungal disease. In some cases, the fungus is a species of Fusarium. Fusarium species infect crops worldwide, resulting in yield loss and reduced quality. In some embodiments, the pathogen is a Fusarium species disclosed in Table 4.

TABLE 4
Fusarium species (adapted from Thrane, U. Fusarium
“Encyclopedia of Food Microbiology (1999) 901-906)

| Fusarium species | Habitat | Crop |
|---|---|---|
| F. avenaceum | Worldwide | Cereals, peaches, apples, pears, |
| | | potatoes, peanuts, peas, asparagus, |
| | | tomatoes |
| F. cerealis | Worldwide | Cereals, potatoes |
| F. culmorum | Temperate regions | Cereals, potatoes, apples, sugar beet |
| F. equiseti | Worldwide | Cereals and fruits contaminated with |
| | | soil, vegetables, nuts, spices, UHT- |
| | | processed juices |
| F. graminearum | Worldwide | Cereals and grasses |
| F. oxysporum | Worldwide | Cereals, peas, beans, nuts, bananas, |
| | | onions, potatoes, citrus fruits, apples, |
| | | cannabis, UHT-processed juices, |
| | | spices, cheese |
| F. poae | Temperate regions | Cereals, soybeans, sugar cane, rice |
| F. proliferatum | Warmer to tropical | Corn, rice, figs, fruits, cannabis |
| | regions | |
| F. sambucinum | Worldwide | Cereals, potatoes |
| F. semitectum | Warmer to tropical | Nuts, bananas, citrus, potatoes, |
| | regions | melons, tomatoes, spices |
| F. solani | Worldwide | Fruits and vegetables, spices, |
| | | cannabis |
| F. sporotrichioides | Worldwide | Cereals, pome fruits |
| F. subglutinans | Worldwide | Corn, pineapple, bananas, spices, |
| | | sorghum |
| F. tricinctum | Worldwide | Cereals |
| F. venenatum | Temperate regions | Cereals, potatoes |
| F. verticillioides | Subtropical and | Corn, rice, sugarcane, bananas, |
| | tropical regions | asparagus, spices, cheese, garlic |
| F. ventricosum | Worldwide | Fruits and vegetables, spices, |
| | | cannabis |

In some embodiments, the methods and compositions disclosed herein prevent Fusarium infection. In some embodiments, the methods and compositions disclosed herein treat a Fusarium infection. In some cases, the Fusarium species is F. oxysporum, F. proliferatum, F. ventricosum, or F. solani.

In some embodiments, the methods and compositions disclosed herein prevent or treat powdery mildew infection. In some embodiments, the methods and compositions disclosed herein treat a powdery mildew infection. In some cases, the powdery mildew is Erysiphe spp., Microsphaera spp., Phyllactinia spp., Podosphaera spp., Sphaerotheca spp., Blumeria spp., or Uncinula spp. A number of crops can be affected by powdery mildew, including for example, cereals (wheat, barely), legumes, grape, onion, fruit (apples, pears), gourds, and melons, lilacs, roses, strawberries, trees, and Arabidopsis.

In some embodiments, the methods and compositions disclosed herein prevent or treat Botrytis infections, for example grey mold caused by Botrytis cinerea.

In some embodiments, compositions and methods of the disclosure are useful in reducing the damage to host plants, i.e., protecting host plants (e.g., agricultural plants) from one or more bacterial diseases. Exemplary plant disease-causing bacteria include, but are not limited to, Pseudomonas avenae, Xanthomonas campestris, Enterobacter dissolvens, Erwinia carotovora, Pseudomonas syringae, Clavibacter michiganensis, Pseudomonas syringae, Bacillus subtilis, Erwinia stewartii, Spiroplasma kunkelli, Pseudomonas amygdali, Curtobacterium flaccumfaciens, and Ralstonia solanacearum.

In some embodiments, disclosed methods may be useful in reducing the damage to host plants, i.e., protecting plants, (e.g., agricultural crops) from one or more fungal diseases. Exemplary fungi include, but are not limited to, Colletotrichum graminicola, Aspergillus flavus, Rhizoctonia solani, Acremonium strictum, Lasiodiploda theobromae, Marasmiellus sp., Physoderma maydis, Acremonium strictum, Macrophomina phaseolina, Thanatephorus, Curvularia clavata, Didymella exitalis, Diplodia maydis, Stenocarpella macrospora, Sclerophthora rayssiae, Sclerophthora macrospora, Sclerospora graminicola, Peronosclerospora maydis, Peronosclerospora philippinensis, Peronosclerospora sorghi, Peronosclerospora spontanea, Peronosclerospora sacchari, Nigrospora oryzae, Alternaria alternate, Claviceps gigantean, Aureobasidium zeae, Fusarium subglutnans, Fusarium moiliforme, Fusarium avenaceum, Gibberella zeae, Botryosphaeria zeae, Cercospora sorghi, Exserohilum pedicellatum, Cladosporium cladosporioides, Hyalothyridium maydis, Cephalosporium maydis, Setsphaeria turcica, Cochliobolus carbonum, Penicillium spp., Phaeocytostroma ambiguum, Phaeosphaeria maydis, Botryosphaeria, Diplodia frument, Phoma terrestris, Phythium spp., Pythium aphanidermmatum, Epicoccum nigrum, Rhizoctonia zeae, Rhizoctonia solani, Setosphaeria rostrata, Puccinia sorghi, Puccinia polysora, Physopella pallescens, Sclerotium rolfsii, Bipolaris sorokiniana, Selenophoma sp., Gaeumannomyces graminis, Myrothecium gramineum, Monascus purpureus, Ustilago zeae, Ustilaginoidea vixens, Sphacelotheca reiliana, Cochliobolus heteroostrophus, Stenocarpella macrospora, Cercospora sorghi, Aspergillus spp., Phyllachora maydis, Trichoderma viride, Stenocarpella maydis, Ascochyta ischaemi, Alternaria spp., Colletotrichum truncatum, Arkoola nigra, Thielaviopsis basicola, Septoria glycines, Phialophora gregata, Macrophomina phaseolina, Choanephora infundibulifera, Pythium ultmum, Peronospora manshurica, Drechslera glycines, Cercospora sojina, Fusarium spp., Leptosphaerulina trifolii, Mycoleptodiscus terrestris, Neocosmospora vasinfecta, Phomopsis spp., Phytophtora sojae, Phymatotrichopsis omnivore, Diaporthe phaseolorum, Microsphaera diffusa, Cercospora kikuchi, Pyrenochaeta glycines, Pythium aphanidermatum, Cylindrocladium crotalariae, Dactuliochaeta glycines, Rhizoctonia solani, Phakopsora pachyrhizi, Spaceloma glycines, Sclerotinia sclerotiorum, Sclerotium rolfsii, Diaporthe phaseolorum, Stemphylium botryosum, Fusarium solani, Corynespora cassiicola, Nematospora coryli, and Cloeocercospora sorghi.

In some embodiments, the compositions and methods of the disclosure are useful in suppressing, reducing, delaying, preventing, or treating infection by a pathogen from a genus selected from the list consisting of: Albugo, Alternaria, Aphanomyces, Aschochyta, Aspergillus, Bipolaris, Blumeria, Botrytis, Cercospora, Colletotrichum, Didymella, Erysiphe, Fusarium, Leptosphaeria, Magnaporthe, Melampsora, Microdochium, Mycosphaerella, Peronospora, Phakopsora, Phytophthora, Plasmodiophora, Plasmopara, Puccinia, Pyrenophora, Pythium, Rhizoctonia, Rhizopus, Septoria, Sclerotium, Stemphylium, Tilletia, Uromyces, Ustilago, and Venturia. In some embodiments, the compositions and methods of the disclosure are useful in suppressing, reducing, delaying, preventing, or treating infection by a pathogen of a species selected from the list consisting of Ascochyta rabei, Alternaria carthami, Bipolaris sorokiana, Botrytis cinerea, Pyrenophora teres, and Rhizopus stolonifer.

In some embodiments, the compositions and methods of the disclosure are useful in reducing the damage to host plants, i.e., protecting plants (e.g., agricultural crops) from one or more parasitic nematodes. Exemplary parasitic nematodes include, but are not limited to, Dolichodorus spp., Ditylenchus dipsaci, Radopholus similis, Heterodera avenae, Xiphinema spp., Nacobbus dorsalis, Hoplolaimus columbus, Hoplolaimus spp., Pratylenchus spp., Longidorus spp., Circonemella spp., Meloidogyne spp., Helicotylenchus spp., Belonolaimus spp., Paratrichodorus spp., Tylenchorhynchus dubius, Paratylenchus projectus, Rotylenchulus reniformis, Criconemella ornate, Meloidogyne arenaria, Hemicycliophora spp., Heterodera glycines, Belonolainus gracilis, Paratrichodorus minor, and Quinisulcius acutus.

### Plants

Any plant (any living organism belonging to the kingdom Plantae) may benefit from the methods and compositions disclosed herein. Examples include, but are not limited to, trees, herbs, bushes, grasses, vines, ferns, mosses, corn, potatoes, roses, apple trees, sunflowers, wheat, rice, bananas, cannabis (hemp and marijuana varieties), pumpkins, squash, lettuce, cabbage, oak trees, guzmania, geraniums, hibiscus, clematis, poinsettias, sugarcane, taro, duck weed, pine trees, Kentucky blue grass, zoysia, coconut trees, brassica leafy vegetables (e.g. broccoli, broccoli raab, Brussels sprouts, cabbage, Chinese cabbage (Bok Choy and Napa), cauliflower, cavalo, collards, kale, kohlrabi, mustard greens, rape greens, and other brassica leafy vegetable crops), bulb vegetables (e.g. garlic, leek, onion (dry bulb, green, and Welch), shallot, and other bulb vegetable crops), citrus fruits (e.g. grapefruit, lemon, lime, orange, tangerine, citrus hybrids, pummelo, and other citrus fruit crops), cucurbit vegetables (e.g. cucumber, citron melon, edible gourds, gherkin, muskmelons (including hybrids and/or cultivars of Cucumis melons), water-melon, cantaloupe, and other cucurbit vegetable crops), fruiting vegetables (including eggplant, ground cherry, pepino, pepper, tomato, tomatillo, and other fruiting vegetable crops), grape, leafy greens (e.g. romaine), root/tuber and corm vegetables (e.g. potato), and tree nuts (almond, pecan, pistachio, and walnut), berries (e.g., barberries, currants, elderberryies, gooseberries, honeysuckles, mayapples, nannyberries, Oregon-grapes, see-buckthorns, hackberries, bearberries, lingonberries, strawberries, sea grapes, lackberries, cloudberries, loganberries, raspberries, salmonberries, thimbleberries, and wineberries), cereal crops (e.g., corn, rice, wheat, barley, sorghum, millets, oats, ryes, triticales, buckwheats, fonio, and quinoa), pome fruit (e.g., apples, pears), stone fruits (e.g., coffees, jujubes, mangos, olives, coconuts, oil palms, pistachios, almonds, apricots, cherries, damsons, nectarines, peaches and plums), vine (e.g., table grapes, wine grapes), fibber crops (e.g. hemp, cotton), ornamentals, and the like.

In some embodiments, the plant is important or interesting for agriculture, horticulture, biomass for the production of biofuel molecules and other chemicals, and/or forestry. Some examples of these plants may include pineapple, banana, coconut, lily, grasspeas and grass; and dicotyledonous plants, such as, for example, peas, alfalfa, tomatillo, melon, chickpea, chicory, clover, kale, lentil, soybean, tobacco, potato, sweet potato, radish, cabbage, rape, apple trees, grape, cotton, sunflower, thale cress, canola, citrus (including orange, mandarin, kumquat, lemon, lime, grapefruit, tangerine, tangelo, citron, and pomelo), pepper, bean, lettuce, Panicum virgatum (switch), Sorghum bicolor (sorghum, sudan), Miscanthus giganteus (miscanthus), Saccharum sp. (energycane), Populus balsamifera (poplar), Zea mays (corn), Glycine max (soybean), Brassica napus (canola), Triticum aestivum (wheat), Gossypium hirsutum (cotton), Oryza sativa (rice), Helianthus annuus (sunflower), Medicago sativa (alfalfa), Beta vulgaris (sugarbeet), Pennisetum glaucum (pearl millet), Panicum spp. Sorghum spp., Miscanthus spp., Saccharum spp., Erianthus spp., Populus spp., Secale cereale (rye), Salix spp. (willow), Eucalyptus spp. (eucalyptus), Triticosecale spp. (triticum-25 wheat X rye), Bamboo, Carthamus tinctorius (safflower), Jatropha curcas (Jatropha), Ricinus communis (castor), Elaeis guineensis (oil palm), Phoenix dactylifera (date palm), Archontophoenix cunninghamiana (king palm), Syagrus romanzoffiana (queen palm), Linum usitatissimum (flax), Brassica juncea, Manihot esculenta (cassaya), Lycopersicon esculentum (tomato), Lactuca saliva (lettuce), Musa paradisiaca (banana), Solanum tuberosum (potato), Brassica oleracea (broccoli, cauliflower, brussel sprouts), Camellia sinensis (tea), Fragaria ananassa (strawberry), Theobroma cacao (cocoa), Coffea arabica (coffee), Vitis vinifera (grape), Ananas comosus (pineapple), Capsicum annum (hot & sweet pepper), Allium cepa (onion), Cucumis melo (melon), Cucumis sativus (cucumber), Cucurbita maxima (squash), Cucurbita moschata (squash), Spinacea oleracea (spinach), Citrullus lanatus (watermelon), Abelmoschus esculentus (okra), Solanum melongena (eggplant), Papaver somniferum (opium poppy), Papaver orientale, Taxus baccata, Taxus brevifolia, Artemisia annua, Cannabis saliva, Camptotheca acuminate, Catharanthus roseus, Vinca rosea, Cinchona officinalis, Coichicum autumnale, Veratrum californica, Digitalis lanata, Digitalis purpurea, Dioscorea 5 spp., Andrographis paniculata, Atropa belladonna, Datura stomonium, Berberis spp., Cephalotaxus spp., Ephedra sinica, Ephedra spp., Erythroxylum coca, Galanthus wornorii, Scopolia spp., Lycopodium serratum (Huperzia serrata), Lycopodium spp., Rauwolfia serpentina, Rauwolfia spp., Sanguinaria canadensis, Hyoscyamus spp., Calendula officinalis, Chrysanthemum parthenium, Coleus forskohlii, Tanacetum parthenium, Parthenium argentatum (guayule), Hevea spp. (rubber), Mentha spicata (mint), Mentha piperita (mint), Bixa orellana, Alstroemeria spp., Rosa spp. (rose), Dianthus caryophyllus (carnation), Petunia spp. (petunia), Poinsettia pulcherrima (poinsettia), Nicotiana tabacum (tobacco), Lupinus albus (lupin), Uniola paniculata (oats), Hordeum vulgare (barley), and Lolium spp. (rye).

In some embodiments, plant tissues or plant parts from a monocotyledonous plant are treated. Monocotyledonous plants belong to the orders of the Alismatales, Arales, Arecales, Bromeliales, Commelinales, Cyclanthales, Cyperales, Eriocaulales, Hydrocharitales, Juncales, Lilliales, Najadales, Orchidales, Pandanales, Poales, Restionales, Triuridales, Typhales, and Zingiberales. Plants belonging to the class of the Gymnospermae are Cycadales, Ginkgoales, Gnetales, and Pinales. In some embodiments, the monocotyledonous plant can be selected from the group consisting of a maize, rice, wheat, barley, and sugarcane.

In some embodiments, plant tissues or plant parts from a dicotyledonous plant are treated, including those belonging to the orders of the Aristochiales, Asterales, Batales, Campanulales, Capparales, Caryophyllales, Casuarinales, Celastrales, Cornales, Diapensales, Dilleniales, Dipsacales, Ebenales, Ericales, Eucomiales, Euphorbiales, Fabales, Fagales, Gentianales, Geraniales, Haloragales, Hamamelidales, Middles, Juglandales, Lamiales, Laurales, Lecythidales, Leitneriales, Magniolales, Malvales, Myricales, Myrtales, Nymphaeales, Papeverales, Piperales, Plantaginales, Plumb aginales, Podostemales, Polemoniales, Polygalales, Polygonales, Primulales, Proteales, Rafflesiales, Ranunculales, Rhamnales, Rosales, Rubiales, Salicales, Santales, Sapindales, Sarraceniaceae, Scrophulariales, Theales, Trochodendrales, Umbellales, Urticales, and Violates. In some embodiments, the dicotyledonous plant can be selected from the group consisting of cotton, soybean, pepper, and tomato.

In some embodiments, the plant is hemp. In some embodiments, the plant is a grape plant. In some embodiments, the plant is a strawberry plant.

### Cannabis

Cannabis is an important crop for a number of reasons. Commodity products produced from cannabis include nearly everything from the industrial industries to the pharmaceutical industries, with some cultivars being bred for use as both fiber and extracts (i.e., CBD). Economic thresholds and injury levels are still being developed for cannabis, and will likely differ for those pest-plant relationships affecting seed production, fiber production, and pharmaceuticals.

A number of pests and diseases affect both hemp and marijuana varieties, however a continuing problem with approved treatments for pests has been ongoing because of the Environmental Protection Agency (EPA)'s inability to recognize cannabis as an existing crop group, given that it remains illegal under federal law. This has led to varying responses and restrictions at the state level. Consequently, the only pesticides that can legally be applied to cannabis under California state law are pesticides with active ingredients that are exempt from reside tolerance requirements and either i) exempt from registration or ii) registered for a use broad enough to encompass cannabis (CDPR 2017). Even with these strict limitations, the Department of Cannabis Control requires cannabis cultivation to submit every lot to be tested for Category I and Category II Residual Pesticides. If the sample exceeds any of the established threshold values, then the batch from which the sample was derived will not be released. Currently there are eleven (11) fungicide screenings that are required as part of this testing criteria (CITE). Based on the work of Valdes-Donoso et al (2020), the estimated testing cost is $136 or 10% of the reported average wholesale price of legal cannabis in the State, all of which is borne by the consumer.

A publication from 1996 reports on almost 300 species of pest arthropods that colonize cannabis worldwide (McPartland, J. M. 1996. Cannabis pests. J. Int. Hemp Assoc. 3:52-55). Examples include, but are not limited to, cannabis aphid, two spotted spider mite, hemp russet mite, corn earworm, corn rootworm/spotted cucumber beetle, tree crickets, hemp flea beetle, hop aphids, tarnished plant bugs, grasshoppers, Noctuids (for example, beet armyworm, variegated cutworm, Bertha armyworm, yellowstriped armyworm, zebra caterpillar), woollybear caterpillars (yellow woollybear, saltmarsh caterpillar), beet webworm, painted lady butterflies, cotton square borer, stink bugs, Lygus bugs, Japanese beetle, western black flea beetle, palestriped flea beetle, Eurasian hemp borer, western flower thrips, whiteflies, broad mites, and fungus gnats (for additional pests affecting cannabis see for example, Whitney Cranshaw, et al., Developing Insect Pest Management Systems for Hemp in the United States: A Work in Progress, Journal of Integrated Pest Management, Volume 10, Issue 1, 2019, 26; Groves, R. et al., Insect and mite pests of field grown hemp in Wisconsin, available on the world wide web at: ipcm.wisc.edu/download/pubsPM/Hemp_Insects_final.pdf; Science of Hemp: Production and Pest Management, University of Kentucky College of Agriculture, Food and Environment, available on the world wide web at: plantpathology.ca.uky.edu/files/sr112.pdf).

With increasing cultivation, the incidence of previously unreported pathogens is growing via anecdotal and peer-reviewed means. Currently, several pathogens causing what is referred to as “bud rot”, such as Botrytis cinerea, and several species of Fusarium (F. oxysporum, F. solani, F. sporotrichioides) are of significant concern.

Induced Systemic Resistance (ISR) is a phenomenon characterized by soil-inhabiting rhizobacteria repressing soil-borne, necrotrophic pathogens and said pathogens are often susceptible for jasmonate-mediated defense (Glazebrook, 2005). By reinforcing jasmonate mediated defenses through ISR elicitation, beneficial bacteria can be considered suitable targets for biocontrol development. Furthermore, consortia of Bacillus have demonstrated beneficial responses against Botyris and Fusarium in a wide range of crops, but not yet verified in hemp or cannabis.

A number of cannabis pests and pathogens may be controlled, repelled, or prevented using the methods and composition disclosed herein. In some cases, bi-weekly (every two weeks) applications of these compositions can keep plants unfavorable to pests and pathogens throughout the growing season.

### EXAMPLES

### Example 1: Control of Strawberry Pests and Pathogens

Methyl dihydrojasmonate (MDJ) was applied to fields of strawberry to investigate the efficacy of MDJ in preventing Botriytis disease. A composition comprising 22.6% w/v MDJ, 49.8% v/v TWEEN-20, and water was diluted at a rate of 32 oz. (1 liter) per 50 gallons of water (approximately a 5 mM solution of MDJ). The composition was then applied (at a rate of 50 gallons per acre) to an acre of ‘Maverick’ strawberries grown in Watsonville, CA on Aug. 18, 2021 and again on Sep. 2, 2021 using an electrostatic backpack sprayer (foliar spray). Plants were harvested in October 2021. MDJ plants were compared to strawberries treated with the grower standard; a rotation of Pristine® (pyraclostrobin and boscalid), Merivon® (pyraclostrobin), Luna® (fluopyram and trifloxystrobin), and Elevate® (fenhexamid).

MDJ treated plants had a lower incidence of Botrytis. Out of four replicates of 10 plants each, the average incidence of Botrytis on berries in the MDJ treated acre was 11%, compared to 18.75% in the grower standard population.

TABLE 5
Percent Botrytis Incidence in Strawberry treated with MDJ

| | MDJ treated | Grower standard |
|---|---|---|
| Replicate # | % incidence | % incidence |
| 1 | 10 | 17 |
| 2 | 16 | 21 |
| 3 | 7 | 17 |
| 4 | 11 | 20 |
| Average | 11 | 18.75 |

While the MDJ composition was applied at a rate of 32 oz per acre, the composition may be applied anywhere between 16 and 64 oz per acre (approximately between 2.5 mM and 10 mM MDJ).

A biological comprising Bacillus subtillis (4.0×10⁹ CFU/ml), Bacillus pumilus (4.0×10⁹ CFU/ml), and Bacillus amyloliquefaciens (2.0×10⁹ CFU/ml) was also applied to fields of strawberry to investigate the efficacy in preventing Botrytis disease. Two different treatment levels were evaluated. In the first, the biological was applied at a rate of 2 quarts per acre (diluted in 50 gallons of water). In the second, the same biological composition was applied at a rate of 1 quart per acre (diluted in 50 gallons of water). The biological compositions were applied twice, four weeks apart, to ‘Maverick’ strawberries grown in Watsonville, CA on May 5, 2021 and Jun. 7, 2021 using an electrostatic backpack sprayer (foliar spray). Plants were harvested on Aug. 5, 2021. Plants treated with the biological composition were compared to strawberries treated with the grower standard; a rotation of Pristine® (pyraclostrobin and boscalid), Merivon® (pyraclostrobin), Luna® (fluopyram and trifloxystrobin), and Elevate® (fenhexamid).

Plants treated with the biological composition had a lower incidence of Botrytis. Out of four replicates of 25 plants each, the average incidence of Botrytis on berries in the biologics-treated acres were 7.75% (1 qt/acre) and 4.75% (2 qt/acre) compared to 17.87% in the grower standard population.

TABLE 6
Percent Botrytis Incidence in Strawberry treated with biological

| | 1 qt/acre | 2 qt/acre | |
|---|---|---|---|
| Replicate | treated % | treated % | Grower standard |
| # | incidence | incidence | % incidence |
| 1 | 7.1 | 6.1 | 18.1 |
| 2 | 6.6 | 5.4 | 17.2 |
| 3 | 8.2 | 4.2 | 16.9 |
| 4 | 9.1 | 3.3 | 19.3 |
| Average | 7.75 | 4.75 | 17.87 |

Thus, a method of preventing fungal pathogens in strawberry plants in envisioned wherein both a biochemical composition comprising a jasmonate such as MDJ, and a biological composition, such as TRIBUS®-original, are applied in conjunction during the growing season. The compositions may be applied separately, or combined into a single composition, and may be applied one or more times as needed.

Pests that affect strawberry including, for example, strawberry root weevils, meadow spittlebug, tarnished plant bug, sap beetles, slugs, and two-spotted spider mites, may also be controlled, repelled, or prevented by the methods and compositions disclosed herein.

### Example 2: Control of Grape Pests and Pathogens

Methyl dihydrojasmonate (MDJ) was applied to fields of grape to investigate the efficacy of MDJ in preventing bunch rot on (Botrytis cinerea) and powdery mildew (Erysiphe necator) on grapes. A composition comprising 22.6% w/v MDJ, 49.8% v/v TWEEN-20, and water was diluted at a rate of 32 oz. (1 liter) per 50 gallons of water (approximately a 5 mM solution of MDJ). The composition was then applied (at a rate of 50 gallons per acre) to three acres (1245 vines/acre) of a cabernet sauvignon variety grown in Napa Valley, CA. There was a total of four applications between June and September using a ground spray rig.

Several leaf and fruit samples were collected to access the presence of powdery mildew under the microscope and compared to leaf and fruit of plants treated with the grower standard. The MDJ treatment exhibited the same, or better, control of powdery mildew as the grower standard.

To investigate the prevalence of Botrytis, the enzyme laccase was analyzed. Laccase can negatively impact wine by causing premature browning of bottled white wine and color degradation in red wine. The MDJ treated group had 2 units/ml, whereas the control (grower standard) had 5 units/ml. This level in the control means that Botrytis problems can be expected during the wine making process, whereas in the MDJ treated group, the value of 2 units/ml means there will be no issues with Botrytis during the wine making process.

While the MDJ composition was applied at a rate of 32 oz per acre, the composition may be applied anywhere between 16 and 64 oz per acre (approximately between 2.5 mM and 10 mM MDJ).

As in the strawberry example above, application of a biological in conjunction with the jasmonate composition may further decrease the prevalence of disease. Additionally, there are a number of pests that affect grapevine that may also be controlled, repelled, or prevented by the compositions and methods disclosed herein. For example, Climbing Cutworms, Grape Berry Moth, Grape Cane Borer, Grape Flea Beetle, Grape Leaffolder, Grape Omnivorous Leafroller, Grape Phylloxera, Grape Root Borer, Grape Rootworm, Grape Tumid Gallmaker, Green June Beetle, Japanese Beetle, Multicolored Asian Lady Beetle, Rose Chafer, Western Grapeleaf Skeletonizer, Leafhoppers, Mealybugs, Mites, and Thrips.

Within the leafhopper category, a number of species are known to cause damage to grapevines, including for example, grape leafhopper (Erythroneura comes), potato leafhopper (Empoasca fabae), Eastern grape leafhopper (Erythroneura comes), glassy-winged sharpshooter (Homalodisca coagulate), three-banded leafhopper (Erythroneura tricincta), Virginia creeper leafhopper (Erythroneura ziczac), Western grape leafhopper (Erythroneura elegantula), and the variegated leafhopper (Erythroneura variabilis) Thresholds for leafhopper vary depending on the generation and species (of insect), type of grape, canopy size, and region.

### Example 3: Control of Cannabis Pests and Pathogens

An experiment similar to that of example 1 was performed in Cannabis.

Culturing Botrytis cinerea: A Botrytis cinerea isolate was cultured onto potato-dextrose agar (PDA). It was resisolated by taking a mycelial plug from the edge of actively growing cultures every 2-3 weeks to maintain active growing culture. It was maintained at 20° C. under continuous light (˜58 pEin m⁻² s⁻¹).

Inoculating hemp: The inoculum was prepared by flooding a full grown B. cinerea PDA plate with DI water and 0.1% Tween-20 to create a suspension of fungal spores. Spore count was quantified.

In the first inoculation, a suspension of 1.2×10⁴ spores of B. cinerea/mL was created, and 1.5 mL was applied to the top cola/inflorescence of each plant. Hemp was inoculated in the first week of flowering, with application to the underdeveloped inflorescences.

In the second inoculation, a suspension of 1.5×10⁵ spores of B. cinerea/mL was created, and sucrose was added to 1% concentration, and the plants were sprayed until drip using a backpack sprayer.

Inoculated plants were placed in a growth chamber or controlled growth environment with a constant temperature of 20-25° C. and 50-70% relative humidity.

See Zhang et al., “Infection Assays of Tomato and Apple Fruit by the Fungal Pathogen Botrytis cinerea,” bio-protocol 2014; 4 (23): 1-4. See also, Bulger et al. Phytopathology 1987; 77 (8): 1225-1230 and Garfinkel, Plant Disease 2020; 104 (7): 2026.

Treatment Conditions: Treatments comprising 1 mM or 5 mM jasmonate (MDJ) were applied alone or alongside a biological (Continuum™). These treatment conditions were compared to control (no MDJ, no biological). Each treatment group had 8 replicates. 500 mL of each treatment solution was prepared for application as a foliar spray. Plants within a treatment condition were sprayed with the corresponding treatment until drip with a hand sprayer. Approximately 400 mL of each treatment were applied per application per plant. Treatments were applied to inflorescences. Table 7 provides the labels and descriptions for each of the treatment conditions.

TABLE 7
Treatment Conditions

| Label | Description |
|---|---|
| A | Control, 0.1% tween/span mixture |
| B | 1 mM MDJ |
| C | 5 mM MDJ |
| D | Continuum ™ only (30 mL per gallon) |
| E | 1 mM MDJ + 30 mL/gallon Continuum ™ |
| F | 5 mM MDJ + 30 mL/gallon Continuum ™ |

Application Timing: The treatments were applied in the first week of flowering, followed 24 hours later by an inoculation of Botrytis cinerea, and then the treatments were applied again four weeks later, followed 24 hours later by another inoculation. Table 8 contains the dates of treatment, inoculation, and harvest.

TABLE 8
Treatment, Infection, and Harvest Dates

| Date | Event |
|---|---|
| May 31, 2022 | First Treatment spray (A-F) |
| Jun. 2, 2022 | First Infection |
| Jun. 28, 2022 | Second Treatment Spray (A-F) |
| Jun. 29, 2022 | Second Infection, with 1% sugar solution |
| Jul. 11, 2022 (week of) | Harvest |

Disease analysis: Botrytis cinerea disease scoring was based on visual inspection of infection amounts. 0: No part of the plant affected; 1: minimal infection, isolated in 1 or 2 areas; 2: mild infection, multiple infection sites, but somewhat isolated; 3: moderate infection, about half of the plant is infected; 4: severe infection, most of the plant is infected; 5: extreme infection, entire plant is infected, with proliferating mold and/or necrotic symptoms occurring.

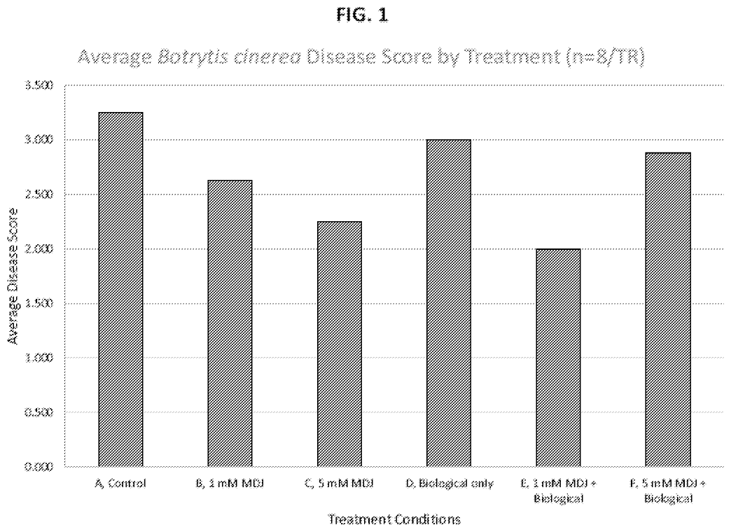

Results: At harvest, the plants in all treatment conditions were evaluated based on their Botrytis disease score (0-5). Table 9 and FIG. 1 show a summary of the average results from each treatment condition. Surprisingly, condition E, with 1 mM MDJ and 30 mL/gallon Continuum™ outperformed all other conditions in terms of reducing disease incidence and/or progression caused by Botrytis cinerea infection. These results suggest a synergistic effect, because the disease score for condition E compared to control is improved more than the sum of the effects of either agent alone (condition B or condition D).

TABLE 9
Average Disease Scores per Treatment Condition

| | Average |
|---|---|
| | Disease |
| Treatment | Score |
| A, Control | 3.250 |
| B, 1 mM MDJ | 2.625 |
| C, 5 mM MDJ | 2.250 |
| D, Biological only | 3.000 |
| E, 1 mM MDJ + Biological | 2.000 |
| F, 5 mM MDJ + Biological | 2.875 |

Similar to the strawberry and grape examples above, a number of cannabis pests and pathogens may be controlled, repelled, or prevented using the methods and composition disclosed herein. In some cases, bi-weekly (every two weeks) applications of these compositions can keep plants unfavorable to pests and pathogens throughout the growing season.

### REFERENCES

Qin J, et al., Endophyte Infection and Methyl Jasmonate Treatment Increased the Resistance of Achnatherum sibiricum to Insect Herbivores Independently. Toxins. 2019; 11 (1): 7.
Egger, B., Koschier, E. H. Behavioural responses of Frankliniella occidentalis Pergande larvae to methyl jasmonate and cis-jasmone. J Pest Sci 87, 53-59 (2014).
McConn M., et al., Jasmonate is essential for insect defense in Arabidopsis. Proceedings of the National Academy of Sciences May 1997, 94 (10) 5473-5477
Puentes A., et al., Variation in Methyl Jasmonate-Induced Defense Among Norway Spruce Clones and Trade-Offs in Resistance Against a Fungal and an Insect Pest. Front. Plant Sci., 24 May 2021.
Senthil-Nathan, S. (2019), Effect of methyl jasmonate (MeJA)-induced defenses in rice against the rice leaffolder Cnaphalocrocis medinalis (Guenèe) (Lepidoptera: Pyralidae). Pest. Manag. Sci., 75:460-465.
Strapasson, P., et al., Enhancing Plant Resistance at the Seed Stage: Low Concentrations of Methyl Jasmonate Reduce the Performance of the Leaf Miner Tuta absoluta but do not Alter the Behavior of its Predator Chrysoperla externa. J Chem Ecol 40, 1090-1098 (2014).
Pineda, A., et al., Non-pathogenic rhizobacteria interfere with the attraction of parasitoids to aphid-induced plant volatiles via jasmonic acid signalling. Plant, Cell, & Environment, (2013) 36, 393-404
Bruinsma, M., et al., Differential effects of jasmonic acid treatment of Brassica nigra on the attraction of pollinators, parasitoids, and butterflies. Entomologia Experimentalis et Applicata 128:109-116, 2008.

### INCORPORATION BY REFERENCE

All references, articles, publications, patents, patent publications, and patent applications cited herein are incorporated by reference in their entireties for all purposes. However, mention of any reference, article, publication, patent, patent publication, and patent application cited herein is not, and should not be taken as an acknowledgment or any form of suggestion that they constitute valid prior art or form part of the common general knowledge in any country in the world. In addition to the publications mentioned throughout the disclosure, the following patent publications are also incorporated by reference herein: U.S. Patent Publication No. 2022/0079150.

### NUMBERED EMBODIMENTS

Not withstanding the claims appended hereto, the disclosure provides the following numbered embodiments:

1. A method of treating or preventing pest infestation and/or pathogen infection of a plant or plant part, the method comprising:
applying (i) a jasmonate and (ii) a biological to the plant, the plant part, or the root zone of the plant,
wherein said application prevents or reduces pest and/or pathogen damage to the plant or plant part compared to untreated plants.

2. A method of treating or preventing pest infestation and/or pathogen infection of a plant or plant part, the method comprising:
applying a jasmonate to the plant, the plant part, or the root zone of the plant,
wherein said application prevents or reduces pest and/or pathogen damage to the plant or plant part compared to untreated plants.

3. The method of embodiment 1, wherein the biological is applied in combination with or at about the same time as the jasmonate.

4. The method of embodiment 1 or 3, wherein the biological is applied separately from the jasmonate.

5. The method of any one of embodiments 1, 3, and 4, wherein the biological is applied before the jasmonate.

6. The method of any one of embodiments 1 and 3-5, wherein the biological is applied about 1, 2, 3, 4, 5, 6, 7, 8, 9, 10, 11, 12, 13, 14, 15, 16, 17, 18, 19, 20, 21, 22, 23, or 24 hours before the jasmonate.

7. The method of any one of embodiments 1 and 3-6, wherein the biological is applied about 1, 2, 3, 4, 5, 6, 7, 8, 9, 10, 11, 12, 13, or 14 days before the jasmonate.

8. The method of any one of embodiments 1 and 3-7, wherein the biological is applied about 1, 2, 3, 4, 5, 6, 7, or 8 weeks before the jasmonate.

9. The method of any one of embodiments 1 and 3-8, wherein the biological is applied about 1, 2, or 3 months before the jasmonate.

10. The method of any one of embodiments 1 and 3-9, wherein the biological is applied after the jasmonate.

11. The method of any one of embodiments 1 and 3-10, wherein the biological is applied about 1, 2, 3, 4, 5, 6, 7, 8, 9, 10, 11, 12, 13, 14, 15, 16, 17, 18, 19, 20, 21, 22, 23, or 24 hours after the jasmonate.

12. The method of any one of embodiments 1 and 3-11, wherein the biological is applied about 1, 2, 3, 4, 5, 6, 7, 8, 9, 10, 11, 12, 13, or 14 days after the jasmonate.

13. The method of any one of embodiments 1 and 3-12, wherein the biological is applied about 1, 2, 3, 4, 5, 6, 7, or 8 weeks after the jasmonate.

14. The method of any one of embodiments 1 and 3-13, wherein the biological is applied about 1, 2, or 3 months after the jasmonate.

15. The method of any one of embodiments 1 and 3-14, wherein the application of the biological is a root drench, granule application, or foliar spray.

16. The method of any one of embodiments 1 and 3-15, wherein the biological is a biofertilizer comprising plant beneficial microbes.

17. The method of any one of embodiments 1 and 3-16, wherein the biological comprises plant growth-promoting rhizobacteria.

18. The method of any one of embodiments 1 and 3-17, wherein the biological comprises species of bacteria from the genera of Azospirillum, Bacillus, Paenibacillus, and/or Pantoea.

19. The method of any one of embodiments 1 and 3-18, wherein the biological comprises species of Azospirillum brasilense, Bacillus amyloliquefaciens, Bacillus laterosporus, Bacillus licheniformis, Bacillus pumilus, Bacillus subtilis, Bacillus thuringiensis, Paenibacillus chitinolyticus, and/or Pantoea dispersa.

20. The method of any one of embodiments 1 and 3-19, wherein the biological comprises Azospirillum brasilense strain Pbio1, Azospirillum brasilense strain Pbul1, Azospirillum brasilense strain Pnem1, Azospirillum brasilense strain Pstr1, Bacillus amyloliquefaciens strain Icon4, Bacillus amyloliquefaciens strain Itri3, Bacillus amyloliquefaciens strain Pbot1, Bacillus pumilus strain Icon3, Bacillus pumilus strain Itri2, Bacillus spp. strain Pnem2, Bacillus subtilis strain Icon2, Bacillus subtilis strain Itri1, Bacillus thuringiensis var. kurstaki strain Pbel1, Bacillus thuringiensis var. kurstaki strain Pbel1F, Bacillus thuringiensis var. kurstaki strain Pbel1S, Bacillus thuringiensis var. kurstaki strain Pbel116SC, Bacillus thuringiensis var. kurstaki strain Plep1, Paenibacillus chitinolyticus strain Icon1, Pantoea dispersa strain Pbio2, and/or Pantoea dispersa strain Pbul2.

21. The method of any one of embodiments 1 and 3-20, wherein the biological comprises about 10⁵ to 10⁹ CFU/mL or CFU/g of a plant-beneficial microbe.

22. The method of any one of embodiments 1 and 3-21, wherein the biological is applied one or more additional times during the life cycle of the plant.

23. The method of any one of embodiments 1 and 3-22, wherein the biological is a composition comprising Bacillus subtillis, Bacillus pumilus, and Bacillus amyloliquefaciens.

24. The method of any one of embodiments 1 and 3-23, wherein the biological is a liquid composition comprising Bacillus subtillis at a concentration of about 1-10×10⁹ CFU/ml, Bacillus pumilus at a concentration of about 1-10×10⁹ CFU/ml, and Bacillus amyloliquefaciens at a concentration of about 0.5-5×10⁹ CFU/ml.

25. The method of any one of embodiments 1 and 3-24, wherein the biological is a liquid composition comprising Bacillus subtillis at a concentration of about 4×10⁹ CFU/ml, Bacillus pumilus at a concentration of about 4×10⁹ CFU/ml, and Bacillus amyloliquefaciens at a concentration of about 2×10⁹ CFU/ml.

26. The method of any one of embodiments 1 and 3-25, wherein 2 quarts of the liquid biological composition are mixed with 50 gallons of water and applied for application as a foliar spray.

27. The method of any one of embodiments 1 and 3-26, wherein the foliar spray is applied at an application rate of about:
a) 5-6 ounces per plant;
b) 4-5 ounces per plant;
c) 3-4 ounces per plant;
d) 2-3 ounces per plant;
e) 1-2 ounces per plant;
f) 0.1-1 ounce per plant; or
g) 150-500 mL per plant.

28. The method of any one of embodiments 1 and 3-22, wherein the biological is a composition comprising Paenibacillus chitinolyticus, Bacillus subtilis, Bacillus pumilus, and Bacillus amyloliquefaciens.

29. The method of any one of embodiments 1, 3-22, and 28, wherein the biological is a composition comprising about 10⁵-10⁷ CFU/mL Paenibacillus chitinolyticus, about 10⁵-10⁷ CFU/mL Bacillus subtilis, about 10⁵-10⁷ CFU/mL Bacillus pumilus, and about 10⁵-10⁷ CFU/mL Bacillus amyloliquefaciens.

30. The method of any one of embodiments 1, 3-22, and 28-29, wherein the biological is a composition comprising about 10⁶ CFU/mL Paenibacillus chitinolyticus, about 10⁶ CFU/mL Bacillus subtilis, about 10⁶ CFU/mL Bacillus pumilus, and about 10⁶ CFU/mL Bacillus amyloliquefaciens.

31. The method of any one of embodiments 1, 3-22, and 28-30, wherein the biological is applied at an application rate of about:
a) 0.1-5 L/acre; or about
b) 0.1-10 mL per plant.

32. The method of any one of embodiments 1, 3-22, and 28-31, wherein the biological is applied at an application rate of about:
a) 0.1-1 L/acre;
b) 1-2 L/acre;
c) 2-3 L/acre;
d) 3-4 L/acre;
e) 4-5 L/acre;
f) 0.1-1 mL per plant;
g) 1-2 mL per plant;
h) 2-3 mL per plant;
i) 3-4 mL per plant; or
j) 4-5 mL per plant.

33. The method of any one of embodiments 1, 3-22, and 28-32, wherein the biological is applied about twice a week, once a week, once every two weeks, once every three weeks, or once a month.

34. The method of any one of embodiments 1 and 3-22, wherein the biological is a composition comprising Bacillus thuringinesis, Azospirillum brasilense, Pantoea dispersa, and/or Bacillus amyloliquefaciens.

35. The method of any one of embodiments 1, 3-22, and 34, wherein the biological is a composition comprising about 10-50×10⁶ IU/g Bacillus thuringinesis, about 100-1000 g/L Azospirillum brasilense, about 10⁶-10⁹ CFU/mL or about 10⁸-10¹⁰ CFU/g Azospirillum brasilense, about 10⁶-10⁹ CFU/mL or about 10⁸-10¹⁰ CFU/g Pantoea dispersa, and/or about 10⁶-10⁹ CFU/mL Bacillus amyloliquefaciens.

36. The method of any one of embodiments 1, 3-22, and 34-35, wherein the biological is a composition comprising Bacillus amyloliquefaciens.

37. The method of any one of embodiments 1, 3-22, and 34-36, wherein the biological is a composition comprising about 10⁶-10⁹ CFU/mL Bacillus amyloliquefaciens.

38. The method of any one of embodiments 1, 3-22, and 34-37, wherein the biological is a composition comprising about 10⁸ CFU/mL Bacillus amyloliquefaciens.

39. The method of any one of embodiments 1, 3-22, and 34-38, wherein the biological is applied as a foliar spray at a dose of about 12-15 cc/L about every 7-14 days.

40. The method of any one of embodiments 1, 3-22, and 34-39, wherein the biological is applied as a drip irrigation at a rate of about 5-15 L/ha about every 30 days.

41. The method of any one of embodiments 1, 3-22, and 34-40, wherein the biological is applied as a drip irrigation at a rate of about 5 L/ha about 5-7 days after transplanting, about 10 L/ha about 30-40 days after first application, and about 15 L/ha about 50-60 days after first application.

42. The method of any one of embodiments 1-41, wherein the jasmonate is selected from the group consisting of jasmonic acid, methyl dihydrojasmonate, cis-jasmone, transjasmone, methyl (+)-7-isojasmonate, dihydrojasmonate, prohydrojasmone, isojasmone, methyl dihydro iso jasmonate, and their homologues or analogues, isomers, derivatives and conjugates thereof.

43. The method of any one of embodiments 1-42, wherein the jasmonate is methyl dihydrojasmonate.

44. The method of any one of embodiments 1-43, wherein the jasmonate comprises between about 1 mM and about 10 mM of a jasmonate.

45. The method of any one of embodiments 1-44, wherein the jasmonate comprises between about 1 mM and about 5 mM of a jasmonate.

46. The method of any one of embodiments 1-45, wherein the jasmonate comprises between about 0.1 mM and about 1.0 mM of a jasmonate.

47. The method of any one of embodiments 1-46, wherein the jasmonate comprises about 1 mM of a jasmonate.

48. The method of any one of embodiments 1-47, wherein the jasmonate is applied as a foliar spray at an application rate of approximately 50 gallons per acre.

49. The method of any one of embodiments 1-48, wherein the jasmonate is applied as a foliar spray at an application rate of approximately:
a) 5-6 ounces per plant;
b) 4-5 ounces per plant;
c) 3-4 ounces per plant;
d) 2-3 ounces per plant;
e) 1-2 ounces per plant;
f) 0.1-1 ounce per plant; or
g) 150-500 mL per plant.

50. The method of any one of embodiments 1-49, wherein the jasmonate is applied one or more additional times during the life cycle of the plant.

51. A composition comprising:
a) a jasmonate;
b) a biological; and
c) an emulsifier.

52. A kit comprising:
a) a composition comprising a jasmonate; and
b) a biological.

53. The composition of embodiment 51, wherein the composition is formulated for application as a foliar spray.

54. The composition of embodiment 51 or 53, wherein the composition is formulated for application as a root drench.

55. The composition of embodiment 51, 53, or 54, wherein the emulsifier is polysorbate-20.

56. The composition or kit of any one of embodiments 51-55, wherein the jasmonate is selected from the group consisting of jasmonic acid, methyl dihydrojasmonate, cis-jasmone, transjasmone, methyl (+)-7-isojasmonate, dihydrojasmonate, prohydrojasmone, isojasmone, methyl dihydro iso jasmonate, and their homologues or analogues, isomers, derivatives or conjugates thereof.

57. The composition or kit of any one of embodiments 51-56, wherein the jasmonate is methyl dihydrojasmonate.

58. The composition or kit of any one of embodiments 51-57, wherein the jasmonate comprises between about 1 mM and about 10 mM of a jasmonate.

59. The composition or kit of any one of embodiments 51-58, wherein the jasmonate comprises between about 1 mM and about 5 mM of a jasmonate.

60. The composition or kit of any one of embodiments 51-59, wherein the jasmonate comprises between about 0.1 mM and about 1.0 mM of a jasmonate.

61. The composition or kit of any one of embodiments 51-60, wherein the jasmonate comprises about 1 mM of a jasmonate.

62. The composition or kit of any one of embodiments 51-61, wherein the biological is a biofertilizer.

63. The composition or kit of any one of embodiments 51-62, wherein the biological comprises plant growth-promoting rhizobacteria.

64. The composition or kit of any one of embodiments 51-63, wherein the biological comprises species of bacteria from the genera of Azospirillum, Bacillus, Paenibacillus, and/or Pantoea.

65. The composition or kit of any one of embodiments 51-64, wherein the biological comprises species of Azospirillum brasilense, Bacillus amyloliquefaciens, Bacillus laterosporus, Bacillus licheniformis, Bacillus pumilus, Bacillus subtilis, Bacillus thuringiensis, Paenibacillus chitinolyticus, and/or Pantoea dispersa.

66. The composition or kit of any one of embodiments 51-65, wherein the biological comprises Azospirillum brasilense strain Pbio1, Azospirillum brasilense strain Pbul1, Azospirillum brasilense strain Pnem1, Azospirillum brasilense strain Pstr1, Bacillus amyloliquefaciens strain Icon4, Bacillus amyloliquefaciens strain Itri3, Bacillus amyloliquefaciens strain Pbot1, Bacillus pumilus strain Icon3, Bacillus pumilus strain Itri2, Bacillus spp. strain Pnem2, Bacillus subtilis strain Icon2, Bacillus subtilis strain Itri1, Bacillus thuringiensis var. kurstaki strain Pbel1, Bacillus thuringiensis var. kurstaki strain Pbel1F, Bacillus thuringiensis var. kurstaki strain Pbel1S, Bacillus thuringiensis var. kurstaki strain Pbel116SC, Bacillus thuringiensis var. kurstaki strain Plep1, Paenibacillus chitinolyticus strain Icon1, Pantoea dispersa strain Pbio2, and/or Pantoea dispersa strain Pbul2.

67. The composition or kit of any one of embodiments 51-66, wherein the biological comprises about 10⁵ to 10⁹ CFU/mL or CFU/g of a plant-beneficial microbe.

68. The composition or kit of any one of embodiments 51-67, wherein the biological is a composition comprising Bacillus subtillis, Bacillus pumilus, and Bacillus amyloliquefaciens.

69. The composition or kit of any one of embodiments 51-68, wherein the biological is a liquid composition comprising Bacillus subtillis at a concentration of about 1-10×10⁹ CFU/ml, Bacillus pumilus at a concentration of about 1-10×10⁹ CFU/ml, and Bacillus amyloliquefaciens at a concentration of about 0.5-5×10⁹ CFU/ml.

70. The composition or kit of any one of embodiments 51-69, wherein the biological is a liquid composition comprising Bacillus subtillis at a concentration of about 4×10⁹ CFU/ml, Bacillus pumilus at a concentration of about 4×10⁹ CFU/ml, and Bacillus amyloliquefaciens at a concentration of about 2×10⁹ CFU/ml.

71. The composition or kit of any one of embodiments 51-70, wherein the biological is a composition comprising Paenibacillus chitinolyticus, Bacillus subtilis, Bacillus pumilus, and Bacillus amyloliquefaciens.

72. The composition or kit of any one of embodiments 51-71, wherein the biological is a composition comprising about 10⁵-10⁷ CFU/mL Paenibacillus chitinolyticus, about 10⁵-10⁷ CFU/mL Bacillus subtilis, about 10⁵-10⁷ CFU/mL Bacillus pumilus, and about 10⁵-10⁷ CFU/mL Bacillus amyloliquefaciens.

73. The composition or kit of any one of embodiments 51-72, wherein the biological is a composition comprising about 10⁶ CFU/mL Paenibacillus chitinolyticus, about 10⁶ CFU/mL Bacillus subtilis, about 10⁶ CFU/mL Bacillus pumilus, and about 10⁶ CFU/mL Bacillus amyloliquefaciens.

74. The composition or kit of any one of embodiments 51-73, wherein the biological is a composition comprising Bacillus thuringinesis, Azospirillum brasilense, Pantoea dispersa, and/or Bacillus amyloliquefaciens.

75. The composition or kit of any one of embodiments 51-74, wherein the biological is a composition comprising about 10-50×10⁶ IU/g Bacillus thuringinesis, about 100-1000 g/L Azospirillum brasilense, about 10⁶-10⁹ CFU/mL or about 10⁸-10¹⁰ CFU/g Azospirillum brasilense, about 10⁶-10⁹ CFU/mL or about 10⁸-10¹⁰ CFU/g Pantoea dispersa, and/or about 10⁶-10⁹ CFU/mL Bacillus amyloliquefaciens.

76. The composition or kit of any one of embodiments 51-75, wherein the biological is a composition comprising Bacillus amyloliquefaciens.

77. The composition or kit of any one of embodiments 51-76, wherein the biological is a composition comprising about 10⁶-10⁹ CFU/mL Bacillus amyloliquefaciens.

78. The composition or kit of any one of embodiments 51-77, wherein the biological is a composition comprising about 10⁸ CFU/mL Bacillus amyloliquefaciens.

79. The composition or kit of any one of embodiments 51-78, wherein the biological comprises plant beneficial microbes, and wherein the concentration of the plant beneficial microbes is at least about 100 million colony-forming units (CFU) per milliliter.

80. A method for controlling, preventing, or treating a plant pest infestation or plant pathogen infection comprising: applying The composition or kit of any one of embodiments 51-W to a plant, plant part, or the root zone of the plant.

81. The method of any one of embodiments 1-50 and 80, wherein the application is to the soil.

82. The method of any one of embodiments 1-50 and 80-81, wherein the application is to an aerial part of the plant.

83. The method of any one of embodiments 1-50 and 80-82, wherein the application is as a foliar spray.

84. The method of any one of embodiments 1-50 and 80-83, wherein the application occurs prior to or during emergence of the plant.

85. The method of any one of embodiments 1-50 and 80-84, wherein the application is re-applied every two weeks.

86. The method of any one of embodiments 1-50 and 80-85, wherein the application of the jasmonate is a post-emergent leaf spray.

87 The method of any one of embodiments 1-50 and 80-86, wherein the plant part or root zone of the plant is selected from leaf, seed, flower, inflorescence, soil, stems, branches, and roots.

88. The method of any one of embodiments 1-50 and 80-87, which is a prophylactic method to prevent damage caused by pest infestation and/or pathogen infection compared to an untreated control.

89. The method of any one of embodiments 1-50 and 80-88, which is a method to treat pest infestation and/or pathogen infection, thereby limiting or reducing the damage compared to an untreated control.

90. The method of any one of embodiments 1-50 and 80-89, wherein the method prevents a pest infestation from reaching economic injury level.

91. The method of any one of embodiments 1-50 and 80-90, wherein the application occurs prior to a plant pest infestation reaching an economic threshold.

92. The method of any one of embodiments 1-50 and 80-91, wherein the method reduces number of infected leaves, percent of infected leaves, number of infected fruits, percent of infected fruits, number of dead leaves, percent of dead leaves, number of damaged leaves, percent of damaged leaves, number of damaged fruits, percent of damaged fruits, degree of infection, progression of infection, degree of infestation, or progression of infestation.

93. The method of any one of embodiments 1-50 and 80-92, wherein the plant or plant part is a species of Cannabis, Vitis, or Prunus.

94. The method of any one of embodiments 1-50 and 80-93, wherein the method inhibits transmission or growth of a pathogen.

95. The method of any one of embodiments 1-50 and 80-94, wherein the pathogen is a fungus.

96. The method of any one of embodiments 1-50 and 80-95, wherein the pathogen is a species that causes powdery mildew.

97. The method of any one of embodiments 1-50 and 80-96, wherein the pathogen is a species of Fusarium.

98. The method of any one of embodiments 1-50 and 80-97, wherein the pathogen is a species of Botrytis.

99. The method of any one of embodiments 1-50 and 80-98, wherein the pathogen is Botrytis cinerea.

100. The method of any one of embodiments 1-50 and 80-99, wherein the pathogen is a virus.

101. The method of any one of embodiments 1-50 and 80-100, wherein the pathogen is a bacterium.

102. The method of any one of embodiments 1-50 and 80-101, wherein the plant or plant part is a species of Cannabis.

103. The method of any one of embodiments 1-50 and 80-102, wherein the pest is corn earworm, hemp russet mite, two-spotted spider mite, or cannabis aphid.

104. The method of any one of embodiments 1-50 and 80-103, wherein the plant or plant part is a species of Vitis.

105. The method of any one of embodiments 1-50 and 80-104, wherein the pathogen is a species of Botrytis or a species that causes powdery mildew.

106. The method of any one of embodiments 1-50 and 80-105, wherein the plant or plant part is a species of Prunus.

107. The method of any one of embodiments 1-50 and 80-106, wherein the pest is navel orangeworm.

108. The method of any one of embodiments 1-50 and 80-107, wherein the plant or plant part is a species of Fragaria.

109. The method of any one of embodiments 1-50 and 80-108, wherein the pathogen is a species of Botrytis.

110. The method of any one of embodiments 1-50 and 80-109, wherein the pest is an insect.

111. The method of any one of embodiments 1-50 and 80-110, wherein the pest is an insect, and infestation is prevented or reduced by deterring insect feeding and/or egg laying.

112. The method of any one of embodiments 1-50 and 80-111, wherein the pest is a mite.

113. The method of any one of embodiments 1-50 and 80-112, wherein the pest is a chewing insect.

114. The method of any one of embodiments 1-50 and 80-113, wherein the pest is a soil insect.

115. The method of any one of embodiments 1-50 and 80-114, wherein the pest is a sucking insect.

1. A method of treating or preventing pest infestation and/or pathogen infection of a plant or plant part, the method comprising:
applying (i) a jasmonate and (ii) a biological to the plant, the plant part, or the root zone of the plant,
wherein said application prevents or reduces pest and/or pathogen damage to the plant or plant part compared to untreated plants.

2. A method of treating or preventing pest infestation and/or pathogen infection of a plant or plant part, the method comprising:
applying a jasmonate to the plant, the plant part, or the root zone of the plant,
wherein said application prevents or reduces pest and/or pathogen damage to the plant or plant part compared to untreated plants.

3. The method of claim 1, wherein the biological is applied in combination with or at about the same time as the jasmonate.

4. The method of claim 1, wherein the biological is applied separately from the jasmonate.

5. The method of claim 1, wherein the biological is applied before the jasmonate.

6. The method of claim 1, wherein the biological is applied about 1, 2, 3, 4, 5, 6, 7, 8, 9, 10, 11, 12, 13, 14, 15, 16, 17, 18, 19, 20, 21, 22, 23, or 24 hours before the jasmonate.

7. The method of claim 1, wherein the biological is applied about 1, 2, 3, 4, 5, 6, 7, 8, 9, 10, 11, 12, 13, or 14 days before the jasmonate.

8. The method of claim 1, wherein the biological is applied about 1, 2, 3, 4, 5, 6, 7, or 8 weeks before the jasmonate.

9. The method of claim 1, wherein the biological is applied about 1, 2, or 3 months before the jasmonate.

10. The method of claim 1, wherein the biological is applied after the jasmonate.

11. The method of claim 1, wherein the biological is applied about 1, 2, 3, 4, 5, 6, 7, 8, 9, 10, 11, 12, 13, 14, 15, 16, 17, 18, 19, 20, 21, 22, 23, or 24 hours after the jasmonate.

12. The method of claim 1, wherein the biological is applied about 1, 2, 3, 4, 5, 6, 7, 8, 9, 10, 11, 12, 13, or 14 days after the jasmonate.

13. The method of claim 1, wherein the biological is applied about 1, 2, 3, 4, 5, 6, 7, or 8 weeks after the jasmonate.

14. The method of claim 1, wherein the biological is applied about 1, 2, or 3 months after the jasmonate.

15. The method of claim 1, wherein the application of the biological is a root drench, granule application, or foliar spray.

16. The method of claim 1, wherein the biological is a biofertilizer comprising plant beneficial microbes.

17. The method of claim 1, wherein the biological comprises plant growth-promoting rhizobacteria.

18. The method of claim 1, wherein the biological comprises species of bacteria from the genera of Azospirillum, Bacillus, Paenibacillus, and/or Pantoea.

19. The method of claim 1, wherein the biological comprises species of Azospirillum brasilense, Bacillus amyloliquefaciens, Bacillus laterosporus, Bacillus licheniformis, Bacillus pumilus, Bacillus subtilis, Bacillus thuringiensis, Paenibacillus chitinolyticus, and/or Pantoea dispersa.

20. The method of claim 1, wherein the biological comprises Azospirillum brasilense strain Pbio1, Azospirillum brasilense strain Pbul1, Azospirillum brasilense strain Pnem1, Azospirillum brasilense strain Pstr1, Bacillus amyloliquefaciens strain Icon4, Bacillus amyloliquefaciens strain Itri3, Bacillus amyloliquefaciens strain Pbot1, Bacillus pumilus strain Icon3, Bacillus pumilus strain Itri2, Bacillus spp. strain Pnem2, Bacillus subtilis strain Icon2, Bacillus subtilis strain Itri1, Bacillus thuringiensis var. kurstaki strain Pbel1, Bacillus thuringiensis var. kurstaki strain Pbel1F, Bacillus thuringiensis var. kurstaki strain Pbel1S, Bacillus thuringiensis var. kurstaki strain Pbel116SC, Bacillus thuringiensis var. kurstaki strain Plep1, Paenibacillus chitinolyticus strain Icon1, Pantoea dispersa strain Pbio2, and/or Pantoea dispersa strain Pbul2.

21. The method of claim 1, wherein the biological comprises about 10⁵ to 10⁹ CFU/mL or CFU/g of a plant-beneficial microbe.

22. The method of claim 1, wherein the biological is applied one or more additional times during the life cycle of the plant.

23. The method of claim 1, wherein the biological is a composition comprising Bacillus subtillis, Bacillus pumilus, and Bacillus amyloliquefaciens.

24. The method of claim 1, wherein the biological is a liquid composition comprising Bacillus subtillis at a concentration of about 1-10×10⁹ CFU/ml, Bacillus pumilus at a concentration of about 1-10×10⁹ CFU/ml, and Bacillus amyloliquefaciens at a concentration of about 0.5-5×10⁹ CFU/ml.

25. The method of claim 1, wherein the biological is a liquid composition comprising Bacillus subtillis at a concentration of about 4×10⁹ CFU/ml, Bacillus pumilus at a concentration of about 4×10⁹ CFU/ml, and Bacillus amyloliquefaciens at a concentration of about 2×10⁹ CFU/ml.

26. The method of claim 25, wherein 2 quarts of the liquid biological composition are mixed with 50 gallons of water and applied for application as a foliar spray.

27. The method of claim 26, wherein the foliar spray is applied at an application rate of about:
a) 5-6 ounces per plant;
b) 4-5 ounces per plant;
c) 3-4 ounces per plant;
d) 2-3 ounces per plant;
e) 1-2 ounces per plant;
f) 0.1-1 ounce per plant; or
g) 150-500 mL per plant.

28. The method of claim 1, wherein the biological is a composition comprising Paenibacillus chitinolyticus, Bacillus subtilis, Bacillus pumilus, and Bacillus amyloliquefaciens.

29. The method of claim 1, wherein the biological is a composition comprising about 10⁵-10⁷ CFU/mL Paenibacillus chitinolyticus, about 10⁵-10⁷ CFU/mL Bacillus subtilis, about 10⁵-10⁷ CFU/mL Bacillus pumilus, and about 10⁵-10⁷ CFU/mL Bacillus amyloliquefaciens.

30. The method of claim 1, wherein the biological is a composition comprising about 10⁶ CFU/mL Paenibacillus chitinolyticus, about 10⁶ CFU/mL Bacillus subtilis, about 10⁶ CFU/mL Bacillus pumilus, and about 10⁶ CFU/mL Bacillus amyloliquefaciens.

31. The method of claim 30, wherein the biological is applied at an application rate of about:
a) 0.1-5 L/acre; or about
b) 0.1-10 mL per plant.

32. The method of claim 30, wherein the biological is applied at an application rate of about:
a) 0.1-1 L/acre;
b) 1-2 L/acre;
c) 2-3 L/acre;
d) 3-4 L/acre;
e) 4-5 L/acre;
f) 0.1-1 mL per plant;
g) 1-2 mL per plant;
h) 2-3 mL per plant;
i) 3-4 mL per plant; or
j) 4-5 mL per plant.

33. The method of claim 30, wherein the biological is applied about twice a week, once a week, once every two weeks, once every three weeks, or once a month.

34. The method of claim 1, wherein the biological is a composition comprising Bacillus thuringinesis, Azospirillum brasilense, Pantoea dispersa, and/or Bacillus amyloliquefaciens.

35. The method of claim 1, wherein the biological is a composition comprising about 10-50×10⁶ IU/g Bacillus thuringinesis, about 100-1000 g/L Azospirillum brasilense, about 10⁶-10⁹ CFU/mL or about 10⁸-10¹⁰ CFU/g Azospirillum brasilense, about 10⁶-10⁹ CFU/mL or about 10⁸-10¹⁰ CFU/g Pantoea dispersa, and/or about 10⁶-10⁹ CFU/mL Bacillus amyloliquefaciens.

36. The method of claim 1, wherein the biological is a composition comprising Bacillus amyloliquefaciens.

37. The method of claim 1, wherein the biological is a composition comprising about 10⁶-10⁹ CFU/mL Bacillus amyloliquefaciens.

38. The method of claim 1, wherein the biological is a composition comprising about 10⁸ CFU/mL Bacillus amyloliquefaciens.

39. The method of claim 38, wherein the biological is applied as a foliar spray at a dose of about 12-15 cc/L about every 7-14 days.

40. The method of claim 38, wherein the biological is applied as a drip irrigation at a rate of about 5-15 L/ha about every 30 days.

41. The method of claim 38, wherein the biological is applied as a drip irrigation at a rate of about 5 L/ha about 5-7 days after transplanting, about 10 L/ha about 30-40 days after first application, and about 15 L/ha about 50-60 days after first application.

42. The method of claim 1 or 2, wherein the jasmonate is selected from the group consisting of jasmonic acid, methyl dihydrojasmonate, cis-jasmone, transjasmone, methyl (+)-7-isojasmonate, dihydrojasmonate, prohydrojasmone, isojasmone, methyl dihydro iso jasmonate, and their homologues or analogues, isomers, derivatives and conjugates thereof.

43. The method of claim 1 or 2, wherein the jasmonate is methyl dihydrojasmonate.

44. The method of claim 1 or 2, wherein the jasmonate comprises between about 1 mM and about 10 mM of a jasmonate.

45. The method of claim 1, wherein the jasmonate comprises between about 1 mM and about 5 mM of a jasmonate.

46. The method of claim 1, wherein the jasmonate comprises between about 0.1 mM and about 1.0 mM of a jasmonate.

47. The method of claim 1, wherein the jasmonate comprises about 1 mM of a jasmonate.

48. The method of claim 1 or 2, wherein the jasmonate is applied as a foliar spray at an application rate of approximately 50 gallons per acre.

49. The method of claim 1 or 2, wherein the jasmonate is applied as a foliar spray at an application rate of approximately:
a) 5-6 ounces per plant;
b) 4-5 ounces per plant;
c) 3-4 ounces per plant;
d) 2-3 ounces per plant;
e) 1-2 ounces per plant;
f) 0.1-1 ounce per plant; or
g) 150-500 mL per plant.

50. The method of claim 1 or 2, wherein the jasmonate is applied one or more additional times during the life cycle of the plant.

51. A composition comprising:
a) a jasmonate;
b) a biological; and
c) an emulsifier.

52. A kit comprising:
a) a composition comprising a jasmonate; and
b) a biological.

53. The composition of claim 51, wherein the composition is formulated for application as a foliar spray.

54. The composition of claim 51, wherein the composition is formulated for application as a root drench.

55. The composition of claim 51, wherein the emulsifier is polysorbate-20.

56. The composition of claim 51 or the kit of claim 52, wherein the jasmonate is selected from the group consisting of jasmonic acid, methyl dihydrojasmonate, cis-jasmone, transjasmone, methyl (+)-7-isojasmonate, dihydrojasmonate, prohydrojasmone, isojasmone, methyl dihydro iso jasmonate, and their homologues or analogues, isomers, derivatives or conjugates thereof.

57. The composition of claim 51 or the kit of claim 52, wherein the jasmonate is methyl dihydrojasmonate.

58. The composition of claim 51 or the kit of claim 52, wherein the jasmonate comprises between about 1 mM and about 10 mM of a jasmonate.

59. The composition of claim 51 or the kit of claim 52, wherein the jasmonate comprises between about 1 mM and about 5 mM of a jasmonate.

60. The composition of claim 51 or the kit of claim 52, wherein the jasmonate comprises between about 0.1 mM and about 1.0 mM of a jasmonate.

61. The composition of claim 51 or the kit of claim 52, wherein the jasmonate comprises about 1 mM of a jasmonate.

62. The composition of claim 51 or the kit of claim 52, wherein the biological is a biofertilizer.

63. The composition of claim 51 or the kit of claim 52, wherein the biological comprises plant growth-promoting rhizobacteria.

64. The composition of claim 51 or the kit of claim 52, wherein the biological comprises species of bacteria from the genera of Azospirillum, Bacillus, Paenibacillus, and/or Pantoea.

65. The composition of claim 51 or the kit of claim 52, wherein the biological comprises species of Azospirillum brasilense, Bacillus amyloliquefaciens, Bacillus laterosporus, Bacillus licheniformis, Bacillus pumilus, Bacillus subtilis, Bacillus thuringiensis, Paenibacillus chitinolyticus, and/or Pantoea dispersa.

66. The composition of claim 51 or the kit of claim 52, wherein the biological comprises Azospirillum brasilense strain Pbio1, Azospirillum brasilense strain Pbul1, Azospirillum brasilense strain Pnem1, Azospirillum brasilense strain Pstr1, Bacillus amyloliquefaciens strain Icon4, Bacillus amyloliquefaciens strain Itri3, Bacillus amyloliquefaciens strain Pbot1, Bacillus pumilus strain Icon3, Bacillus pumilus strain Itri2, Bacillus spp. strain Pnem2, Bacillus subtilis strain Icon2, Bacillus subtilis strain Itri1, Bacillus thuringiensis var. kurstaki strain Pbel1, Bacillus thuringiensis var. kurstaki strain Pbel1F, Bacillus thuringiensis var. kurstaki strain Pbel1S, Bacillus thuringiensis var. kurstaki strain Pbel116SC, Bacillus thuringiensis var. kurstaki strain Plep1, Paenibacillus chitinolyticus strain Icon1, Pantoea dispersa strain Pbio2, and/or Pantoea dispersa strain Pbul2.

67. The composition of claim 51 or the kit of claim 52, wherein the biological comprises about 10⁵ to 10⁹ CFU/mL or CFU/g of a plant-beneficial microbe.

68. The composition of claim 51 or the kit of claim 52, wherein the biological is a composition comprising Bacillus subtillis, Bacillus pumilus, and Bacillus amyloliquefaciens.

69. The composition of claim 51 or the kit of claim 52, wherein the biological is a liquid composition comprising Bacillus subtillis at a concentration of about 1-10×10⁹ CFU/ml, Bacillus pumilus at a concentration of about 1-10×10⁹ CFU/ml, and Bacillus amyloliquefaciens at a concentration of about 0.5-5×10⁹ CFU/ml.

70. The composition of claim 51 or the kit of claim 52, wherein the biological is a liquid composition comprising Bacillus subtillis at a concentration of about 4×10⁹ CFU/ml, Bacillus pumilus at a concentration of about 4×10⁹ CFU/ml, and Bacillus amyloliquefaciens at a concentration of about 2×10⁹ CFU/ml.

71. The composition of claim 51 or the kit of claim 52, wherein the biological is a composition comprising Paenibacillus chitinolyticus, Bacillus subtilis, Bacillus pumilus, and Bacillus amyloliquefaciens.

72. The composition of claim 51 or the kit of claim 52, wherein the biological is a composition comprising about 10⁵-10⁷ CFU/mL Paenibacillus chitinolyticus, about 10⁵-10⁷ CFU/mL Bacillus subtilis, about 10⁵-10⁷ CFU/mL Bacillus pumilus, and about 10⁵-10⁷ CFU/mL Bacillus amyloliquefaciens.

73. The composition of claim 51 or the kit of claim 52, wherein the biological is a composition comprising about 10⁶ CFU/mL Paenibacillus chitinolyticus, about 10⁶ CFU/mL Bacillus subtilis, about 10⁶ CFU/mL Bacillus pumilus, and about 10⁶ CFU/mL Bacillus amyloliquefaciens.

74. The composition of claim 51 or the kit of claim 52, wherein the biological is a composition comprising Bacillus thuringinesis, Azospirillum brasilense, Pantoea dispersa, and/or Bacillus amyloliquefaciens.

75. The composition of claim 51 or the kit of claim 52, wherein the biological is a composition comprising about 10-50×10⁶ IU/g Bacillus thuringinesis, about 100-1000 g/L Azospirillum brasilense, about 10⁶-10⁹ CFU/mL or about 10⁸-10¹⁰ CFU/g Azospirillum brasilense, about 10⁶-10⁹ CFU/mL or about 10⁸-10¹⁰ CFU/g Pantoea dispersa, and/or about 10⁶-10⁹ CFU/mL Bacillus amyloliquefaciens.

76. The composition of claim 51 or the kit of claim 52, wherein the biological is a composition comprising Bacillus amyloliquefaciens.

77. The composition of claim 51 or the kit of claim 52, wherein the biological is a composition comprising about 10⁶-10⁹ CFU/mL Bacillus amyloliquefaciens.

78. The composition of claim 51 or the kit of claim 52, wherein the biological is a composition comprising about 10⁸ CFU/mL Bacillus amyloliquefaciens.

79. The composition of claim 51 or the kit of claim 52, wherein the biological comprises plant beneficial microbes, and wherein the concentration of the plant beneficial microbes is at least about 100 million colony-forming units (CFU) per milliliter.

80. A method for controlling, preventing, or treating a plant pest infestation or plant pathogen infection comprising: applying the composition of claim 51 or the kit of claim 52 to a plant, plant part, or the root zone of the plant.

81. The method of claim 1, 2, or 80, wherein the application is to the soil.

82. The method of claim 1, 2, or 80, wherein the application is to an aerial part of the plant.

83. The method of claim 1, 2, or 80, wherein the application is as a foliar spray.

84. The method of claim 1, 2, or 80, wherein the application occurs prior to or during emergence of the plant.

85. The method of claim 1, 2, or 80, wherein the application is re-applied every two weeks.

86. The method of claim 1, 2, or 80, wherein the application of the jasmonate is a post-emergent leaf spray.

87. The method of claim 1, 2, or 80, wherein the plant part or root zone of the plant is selected from leaf, seed, flower, inflorescence, soil, stems, branches, and roots.

88. The method of claim 1, 2, or 80, which is a prophylactic method to prevent damage caused by pest infestation and/or pathogen infection compared to an untreated control.

89. The method of claim 1, 2, or 80, which is a method to treat pest infestation and/or pathogen infection, thereby limiting or reducing the damage compared to an untreated control.

90. The method of claim 1, 2, or 80, wherein the method prevents a pest infestation from reaching economic injury level.

91. The method of claim 1, 2, or 80, wherein the application occurs prior to a plant pest infestation reaching an economic threshold.

92. The method of claim 1, 2, or 80, wherein the method reduces number of infected leaves, percent of infected leaves, number of infected fruits, percent of infected fruits, number of dead leaves, percent of dead leaves, number of damaged leaves, percent of damaged leaves, number of damaged fruits, percent of damaged fruits, degree of infection, progression of infection, degree of infestation, or progression of infestation.

93. The method of claim 1, 2, or 80, wherein the plant or plant part is a species of Cannabis, Vitis, or Prumis.

94. The method of claim 1, 2, or 80, wherein the method inhibits transmission or growth of a pathogen.

95. The method of claim 1, 2, or 80, wherein the pathogen is a fungus.

96. The method of claim 1, 2, or 80, wherein the pathogen is a species that causes powdery mildew.

97. The method of claim 1, 2, or 80, wherein the pathogen is a species of Fusarium.

98. The method of claim 1, 2, or 80, wherein the pathogen is a species of Botrytis.

99. The method of claim 1, 2, or 80, wherein the pathogen is Botrytis cinerea.

100. The method of claim 1, 2, or 80, wherein the pathogen is a virus.

101. The method of claim 1, 2, or 80, wherein the pathogen is a bacterium.

102. The method of claim 1, 2, or 80, wherein the plant or plant part is a species of Cannabis.

103. The method of claim 1, 2, or 80, wherein the pest is corn earworm, hemp russet mite, two-spotted spider mite, or cannabis aphid.

104. The method of claim 1, 2, or 80, wherein the plant or plant part is a species of Vitis.

105. The method of claim 1, 2, or 80, wherein the pathogen is a species of Botrytis or a species that causes powdery mildew.

106. The method of claim 1, 2, or 80, wherein the plant or plant part is a species of Prunus.

107. The method of claim 1, 2, or 80, wherein the pest is navel orangeworm.

108. The method of claim 1, 2, or 80, wherein the plant or plant part is a species of Fragaria.

109. The method of claim 1, 2, or 80, wherein the pathogen is a species of Botrytis.

110. The method of claim 1, 2, or 80, wherein the pest is an insect.

111. The method of claim 1, 2, or 80, wherein the pest is an insect, and infestation is prevented or reduced by deterring insect feeding and/or egg laying.

112. The method of claim 1, 2, or 80, wherein the pest is a mite.

113. The method of claim 1, 2, or 80, wherein the pest is a chewing insect.

114. The method of claim 1, 2, or 80, wherein the pest is a soil insect.

115. The method of claim 1, 2, or 80, wherein the pest is a sucking insect.
